(19) United States
(12) Patent Application Publication
(10) Pub. No.: US 2024/0205875 A1
(43) Pub. Date: Jun. 20, 2024

(54) FIRST NODE, SECOND NODE, OR THE METHOD PERFORMED BY THE SAME

(71) Applicant: Samsung Electronics Co., Ltd., Suwon-si, Gyeonggi-do (KR)

(72) Inventors: Yanru WANG, Beijing (CN); Hong WANG, Beijing (CN); Lixiang XU, Beijing (CN); Weiwei WANG, Beijing (CN); Xiaoning MA, Beijing (CN)

(21) Appl. No.: 18/287,971

(22) PCT Filed: Apr. 25, 2022
(86) PCT No.: PCT/KR2022/005866

§ 371 Date: Oct. 23, 2023

(30) Foreign Application Priority Data
Apr. 29, 2021 (CN) 202110473885.7
Jan. 29, 2022 (CN) 202210112684.9
Apr. 22, 2022 (KR) 10-2022-0049960

(51) Int. Cl. H04W 64/00; H04W 36/24; H04W 36/32; H04W 60/04

(52) U.S. Cl. CPC H04W 64/006; H04W 36/249; H04W 36/324; H04W 60/04

(57) ABSTRACT

The disclosure relates to a 5G or 6G communication system for supporting a higher data transmission rate. A method performed by a first node in a wireless communication system is provided. The method includes acquiring information related to at least one of trajectory prediction of user equipment, data usage prediction of the user equipment, quality of service and/or quality of experience prediction and/or reporting of a second node and/or a user equipment, or positioning of the user equipment, and performing a corresponding operation based on the information.

### TECHNICAL FIELD

The present disclosure relates to the technical field of wireless communication, and in particular to a method performed by a first node, a method performed by a second node, the first node and the second node.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The measurement report based handover mechanism decides whether to perform a handover for a user equipment UE and selects a target node for the handover according to the measurement report reported by the UE. In the case of a conditional handover, a source node selects a list of candidate target nodes according to the measurement report of the UE. When one or more operating conditions are met, the handover process is performed. Such mechanism may cause problems such as wrong target node selection, too early handover, too late handover, ping-pong handover and so on.

Positioning in wireless network does the measurement configuration for multiple nodes; UE and/or a node measures according to the configuration to obtain measurement results; and a network node calculates to obtain location information of the UE through various methods after obtaining the measurement results. If the wireless network does not obtain the current accurate location information of the UE, it will also affect the network node's decision for the UE.

### Solution to Problem

According to an aspect of the present disclosure, there is provided a method performed by a first node, comprising: acquiring information related to at least one of trajectory prediction of user equipment, data usage prediction of the user equipment, quality of service and/or quality of experience prediction and/or reporting of a second node or a user equipment, or positioning of the user equipment; and performing a corresponding operation based on the information.

According to an aspect of the present disclosure, there is provided a method performed by a second node, comprising: transmitting, to a first node, information related to at least one of trajectory prediction of a user equipment, data usage prediction of the user equipment, quality of service and/or quality of experience prediction and/or reporting of the second node and/or the user equipment, or positioning of the user equipment.

According to an aspect of the present disclosure, there is provided a first node, which comprises: a transceiver configured to transmit and receive signals with the outside; and a processor configured to control the transceiver to perform the above methods performed by the first node.

According to an aspect of the present disclosure, there is provided a second node, which comprises: a transceiver configured to transmit and receive signals with the outside; and a processor configured to control the transceiver to perform the above methods performed by the second node.

According to an aspect of the present disclosure, there is provided a non-transitory computer-readable recording medium having stored thereon a program, which when performed by a computer, performs any one of the methods described above.

With respect to the above problems, embodiments of the present disclosure provide a method performed by a first node, a method performed by a second node, the first node and the second node. Through the method performed by the first node, the method performed by the second node, the first node and the second node provided by the present disclosure, the first node can acquire information related to at least one of trajectory prediction of user equipment, data usage prediction of the user equipment, quality of service and/or quality of experience prediction and/or reporting of a second node and/or a UE, or positioning of the user equipment, and perform a corresponding operation based on the above information, so as to provide reference information for the first node to make a decision for the UE about whether or not to perform a handover on the UE, the selection of handover time, the selection of target nodes, etc., thereby reducing the case of handover failures, handover ping-pong, too many candidate target nodes, etc., thereby improving the success rate of the handover. In addition, it helps the first node to make resource allocation decision for the UE, which can improve the effectiveness of resource allocation. Furthermore, it also provides reference information for the first node to do the decision of energy saving, load balancing, etc., so as to ensure the QoS performance after UE performing the handover, the performance after load migration, the performance after the implementation of energy-saving strategy and avoid ping-pong of energy-saving switch; besides, it also provides reference information for the first node or other nodes to make positioning results, so as to improve positioning accuracy, reduce positioning delay, reduce signalling overhead required for positioning, and reduce positioning errors caused by the node synchronization.

### BRIEF DESCRIPTION OF DRAWINGS

FIG. 1 is an exemplary system architecture 100 of system architecture evolution (SAE);

FIG. 2 is an exemplary system architecture 200 according to various embodiments of the present disclosure;

FIG. 3 illustrates a flowchart of a method performed by a first node provided by an embodiment of the present disclosure;

FIG. 4 illustrates a schematic diagram of a process of interaction of information associated with trajectory prediction of user equipment between a first node and a second node according to an embodiment of the present disclosure;

FIG. 5 illustrates another schematic diagram of a process of interaction of information associated with trajectory prediction of user equipment between a first node and a second node according to an embodiment of the present disclosure;

FIG. 6 illustrates yet another schematic diagram of a process of interaction of information associated with trajectory prediction of user equipment between a first node and a second node according to an embodiment of the present disclosure;

FIG. 7 illustrates a schematic diagram of a process of interaction of information associated with trajectory prediction of user equipment between a master node and a secondary node in the case of dual connectivity according to an embodiment of the present disclosure;

FIG. 8 illustrates a schematic diagram of a process of interaction of information associated with data usage reporting requirement of user equipment between a first node and a second node according to an embodiment of the present disclosure;

FIG. 9 illustrates a schematic diagram of a process of interaction of information associated with data usage prediction of user equipment between a first node and a second node according to an embodiment of the present disclosure;

FIG. 10 illustrates another schematic diagram of a process of interaction of information associated with data usage prediction of user equipment between a first node and a second node according to an embodiment of the present disclosure;

FIG. 11 is a schematic diagram of a process of interaction of information associated with data usage prediction of user equipment between nodes according to their own conditions during handover under the split architecture of gNB CU-UP and gNB CU-CP according to an embodiment of the present disclosure;

FIG. 12 is a schematic diagram of a process of interaction of information associated with data usage information of user equipment between nodes according to their own conditions during handover under the split architecture of gNB CU-UP and gNB CU-CP according to an embodiment of the present disclosure;

FIG. 13 illustrates a schematic diagram of a process of interaction of information associated with data usage information of user equipment between a master node and a secondary node according to their own conditions in the case of dual connectivity according to an embodiment of the present disclosure;

FIG. 14 illustrates a schematic diagram of a process of interaction of information associated with achievable QoS prediction, and/or achievable QoS, and/or QoS prediction, and/or QoS, and/or achievable QoE prediction, and/or achievable QoE, and/or QoE prediction, and/or QoE of a second node and/or a UE between a first node and the second node according to an embodiment of the present disclosure;

FIG. 15 illustrates another schematic diagram of a process of interaction of information associated with achievable QoS prediction, and/or achievable QoS, and/or QoS prediction, and/or QoS, and/or achievable QoE prediction, and/or achievable QoE, and/or QoE prediction, and/or QoE of a second node and/or a UE between a first node and the second node according to an embodiment of the present disclosure;

FIG. 16 illustrates yet another schematic diagram of a process of interaction of information associated with achievable QoS prediction, and/or achievable QoS, and/or QoS prediction, and/or QoS, and/or achievable QoE prediction, and/or achievable QoE, and/or QoE prediction, and/or QoE of a second node and/or a UE between a first node and the second node according to an embodiment of the present disclosure;

FIG. 17 illustrates further another schematic diagram of a process of interaction of information associated with achievable QoS prediction, and/or achievable QoS, and/or QoS prediction, and/or QoS, and/or achievable QoE prediction, and/or achievable QoE, and/or QoE prediction, and/or QoE of a second node and/or a UE between a first node and the second node according to an embodiment of the present disclosure;

FIG. 18 illustrates a schematic diagram of a process of interaction of information related to positioning of user equipment between a first node and a second node according to an embodiment of the present disclosure;

FIG. 19 illustrates another schematic diagram of a process of interaction of information related to positioning of user equipment between a first node and a second node according to an embodiment of the present disclosure;

FIG. 20 illustrates a flowchart of a method performed by a second node provided by an embodiment of the present disclosure;

FIG. 21 is a block diagram illustrating the structure of a first node according to an embodiment of the present disclosure;

FIG. 22 is a block diagram illustrating the structure of a second node according to an embodiment of the present disclosure.

### MODE FOR THE INVENTION

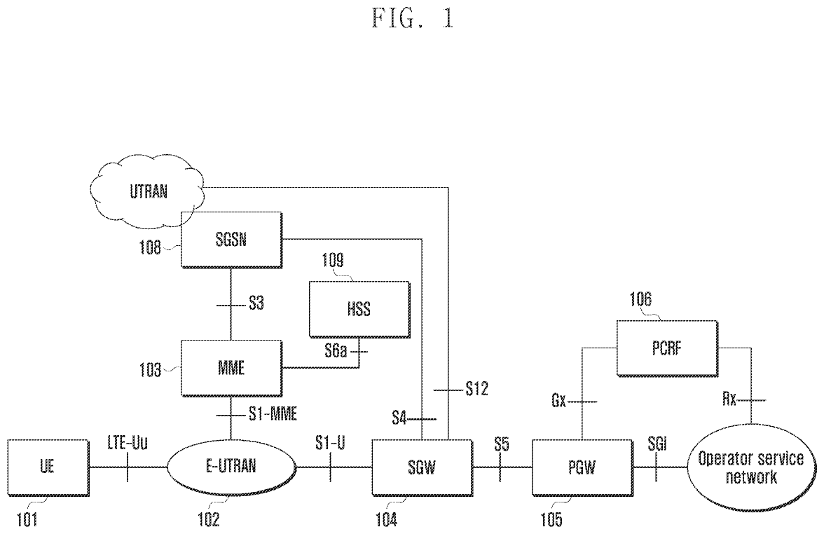

FIGS. 1 to 22 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

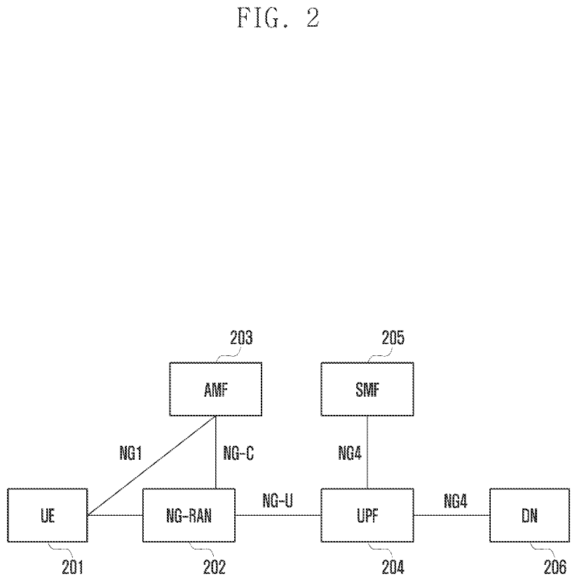

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

The embodiments of the present disclosure will be described in detail from various aspects below. For the convenience of understanding, the embodiment of the present disclosure is described in the way of two sides interacting, but it can be understood that any step or any combination of steps performed by any side belongs to the scope of protection of the present disclosure. It can be understood that the first node and the second node described herein can be a user equipment and/or a base station, and the following messages interacting between the first node and the second node can be RRC messages.

The embodiment of the present disclosure provides a method for supporting data collection and processing by wireless communication network, which includes:
first, the first node transmits a first message including information related to the trajectory prediction request of the user equipment to the second node to request the second node to predict the trajectory of the UE and feedback the information related to the trajectory prediction.

The first message may be, for example, but not limited to, a HANDOVER REQUEST ACKNOWLEDGE message or a RETRIEVE UE CONTEXT REQUEST message or a HANDOVER SUCCESS message of X2 or Xn; a SENB MODIFICATION REQUEST message or a SGNB MODIFICATION REQUEST message or a SENB MODIFICATION REQUIRED message or a SGNB MODIFICATION REQUIRED message of X2, or an S-NODE MODIFICATION REQUEST message or an S-NODE MODIFICATION REQUIRED message of Xn; a HANDOVER COMMAND message or a HANDOVER PREPARATION FAILURE message or a HANDOVER REQUEST ACKNOWLEDGE message or a HANDOVER NOTIFY message or a HANDOVER SUCCESS message or a PATH SWITCH REQUEST message of NG. In addition, the first message may also be a newly defined X2 or Xn or NG message.

The first message may include at least one of the following, for example:

(1) a UE identity, which is used to identify the UE for whom the trajectory prediction needs to be done.

The identity may include, for example, but not limited to, at least one of the following: NG-RAN node UE XnAP ID, Source NG-RAN node UE XnAP ID, MNG-RAN node UE XnAP ID, S-NG-RAN node UE XnAP ID, MeNB UE X2AP ID, SeNB UE X2AP ID, MeNB UE X2AP ID, SgNB UE X2AP ID, AMF UE NGAP ID, RAN UE NGAP ID, Source AMF UE NGAP ID.

(2) a first node identity, which is to identify the node that transmits a trajectory prediction request.

The identity may include, for example, but not limited to, at least one of the following: Cell Global ID, Target Cell Global ID and Requested Target Cell ID.

(3) a second node identity, which is used to identify the node receiving the request.

The identity may include, for example, but not limited to, at least one of the following: Cell Global ID, Target Cell Global ID and Requested Target Cell ID.

(4) handover time of requested user equipment, which is related information used to identify handover time of the requested user equipment.

This time can be, for example, relative time or absolute time.

(5) a prediction identity: the prediction identity is used to identify whether the first message includes related information for requesting prediction or trajectory prediction of the user equipment.

This field can be represented by a single bit. For example, 1 indicates that the request is a request for trajectory prediction, and 0 indicates that the request is not a request for trajectory prediction. Or 1 indicates that the request is a request for prediction, and 0 indicates that the request is not a request for prediction.

(6)a prediction registration request, which is related information used to indicate at least one of the start, end or add of the trajectory prediction request.

(7) a time interval for the requested prediction result, which is related information used to indicate the requested time interval for trajectory prediction result.

The time interval for the requested prediction result can be represented by 2*n bits, for example, the first n bits represent the start time for trajectory prediction results and the last n bits represent the end time for trajectory prediction results, which can be relative time or absolute time.

The time interval for the requested prediction result may also be represented by a separate field, for example, and may include one or more of the following:

(a) start time for prediction result, which is used to indicate the start time for trajectory prediction results. The start time for prediction resultcan be, for example, relative time or absolute time.

(b) end time for prediction result, which is used to indicate the end time for trajectory prediction results. The end time for prediction result may be, for example, relative time or absolute time.

(8) a reporting type of the requested prediction result, which is related information used to indicate whether the reporting of the requested trajectory prediction result is one-time reporting or periodic reporting.

The reporting type of the prediction may include, but are not limited to, an on-demand type, a periodic type, etc.

(9) a reporting period of the requested prediction result, which is related information used to indicate a corresponding interval time when the reporting of the requested trajectory prediction result is periodic reporting.

The reporting period can also be the prediction time of the reported data. If there is no content in this field, it means that a one-time reporting is enough, and the prediction time for a one-time reporting is from the start time for prediction result to the end time for prediction result.

(10) a reporting triggering condition, which is related information used to indicate triggering conditions under which the reporting is needed.

Reporting is needed only when the prediction result or actual situation meets the reporting triggering condition. For example, reporting is needed in the case of long-term camping, short-term camping, ping-pong movement, etc.

(11) a type of the requested prediction, which is related information used to indicate a type of the requested trajectory prediction.

The prediction type may include, for example, but not limited to, trajectory coordinate point prediction, camping cell prediction, connected serving cell prediction, trajectory special case prediction, etc.

(12) requested content of the prediction, which is related information used to indicate parameters of the requested trajectory prediction.

The parameter needs to be predicted may include, for example, but not limited to, a time point, location coordinates, estimated velocity (including speed value and/or direction), cell identity (such as Cell Global ID, etc.), a trajectory special case type, coordinate points and/or area of a trajectory special case, prediction accuracy, etc.

Herein, the trajectory special case type can include, but not limited to, long-term camping, short-term camping, ping-pong movement and so on.

Herein, the coordinate points and/or area of the trajectory special case indicate information of the location where the trajectory special case occurs.

As an implementation, the prediction content may be related to the prediction type. For example, if the prediction type is camping cell prediction or connected serving cell prediction, the prediction content may include but not limited to a time point, cell identity, prediction accuracy, etc. For another example, if the prediction type is selected as trajectory coordinate point prediction, the prediction content may include but not limited to a time point, location coordinates, estimated velocity (including speed value and/or direction), prediction accuracy, etc. For yet another example, if the prediction type is selected as the trajectory special case type, the prediction content may include but not limited to a time point, a trajectory special case type, coordinate points and/or area of the trajectory special case, prediction accuracy, etc.

Then, after receiving the first message, the second node performs trajectory prediction according to the first message, and transmits a second message including information related to trajectory prediction of the user equipment to the first node, so that the first node can acquire information such as the result of trajectory prediction of the UE by the second node.

As another implementation, the second node can also transmit a second message including information related to the trajectory prediction of the user equipment to the first node according to its own situation, instead of transmitting the second message after receiving the first message.

The second message may be, for example, but not limited to, a HANDOVER REQUEST message or a RETRIEVE UE CONTEXT RESPONSE message or a RETRIEVE UE CONTEXT FAILURE message of X2 or Xn. It can also be an SENB MODIFICATION REQUEST ACKNOWLEDGE message or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2. It can also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE of Xn. It can also be a PATH SWITCH REQUEST ACKNOWLEDGE message or a PATH SWITCH REQUEST FAILURE message of NG. In addition, the second message may also be a newly defined X2 or Xn or NG message.

The second message, for example may include one or more of the following:

(1) a UE identity, which is used to identify the UE for whom the trajectory prediction needs to be done.

The identity may include, for example, but not limited to, at least one of the following: NG-RAN node UE XnAP ID, Source NG-RAN node UE XnAP ID, MNG-RAN node UE XnAP ID, S-NG-RAN node UE XnAP ID, MeNB UE X2AP ID, SeNB UE X2AP ID, MeNB UE X2AP ID, SgNB UE X2AP ID, AMF UE NGAP ID, RAN UE NGAP ID, Source AMF UE NGAP ID.

(2) a first node identity, which is used to identify the first node.

The identity may include, for example, but not limited to, at least one of the following: Cell Global ID, Target Cell Global ID and Requested Target Cell ID.

(3) a second node identity, which is used to identify the second node.

The identity may include, for example, but not limited to, at least one of the following: Cell Global ID, Target Cell Global ID and Requested Target Cell ID.

(4) a prediction identity of prediction content, which is related information used to indicate whether trajectory information is the prediction content.

The prediction identity field of prediction content can be expressed by a single bit. For example, a value of 1 indicates that the information is the prediction content, and 0 indicates that the information is the actual state content.

(5) user equipment handover time, which is related information used to identify handover time of the user equipment.

This time can be, for example, relative time or absolute time.

(6) requested content confirmation, which is related information used to confirm whether the requested trajectory prediction content is predicted or not.

The requested content confirmation can be a single bit representation. For example, a bit of 1 indicates that all the requested content can be predicted, and a bit of 0 indicates that the requested content cannot be predicted.

For example, the requested content confirmation can also confirm the prediction request content one by one in the form of bitmap. For example, cach bit corresponds to a prediction content. For example, if the bit is 1, it means that the prediction trajectory information of the corresponding prediction content can be transmitted, while 0 means that the prediction trajectory information of the corresponding prediction content cannot be transmitted.

For example, the requested content confirmation may also be that a separate field indicates different prediction content confirmation.

(7) a time interval for prediction result, which is related information used to indicate a time interval for trajectory prediction result.

The time interval for the prediction can be represented by 2*n bits, for example, the first n bits represent the start time for trajectory prediction results and the last n bits represent the end time for trajectory prediction results, which can be relative time or absolute time.

The time interval for the prediction result may also be represented by a separate field, for example, and may include one or more of the following:

(a) start time for prediction result, which is used to represent the start time for the trajectory prediction results. The start time for prediction result can be, for example, relative time or absolute time.

(b) end time for prediction result which is used to represent the end time for the trajectory prediction results. The end time for prediction resultmay be, for example, relative time or absolute time.

(8) a type of prediction, which is related information used to indicate a type of the performed trajectory prediction.

A prediction type includes, but not limited to, trajectory coordinate point prediction, camping cell prediction, connected serving cell prediction, trajectory special case prediction, etc.

(9) content of prediction, which is related information used to indicate parameters of the performed trajectory prediction.

The parameter predicted may include, for example, but not limited to, a time point, location coordinates, estimated velocity (including speed value and/or direction), cell identity (such as Cell Global ID, etc.), a trajectory special case type, coordinate points and/or area of a trajectory special case, prediction accuracy, etc.

Herein, the trajectory special case type can include, for example, but not limited to, long-term camping, short-term camping, ping-pong movement and so on.

Herein, the coordinate point and/or area of the trajectory special case indicate information of the location where the trajectory special case occurs.

As an implementation, the content of prediction may be related to the type of prediction. For example, if the type of prediction is camping cell prediction or connected serving cell prediction, the content of prediction may include but not limited to a time point, cell identity, prediction accuracy, etc. For another example, if the type of prediction is selected as trajectory coordinate point prediction, the content of prediction may include but not limited to a time point, location coordinates, estimated velocity (including speed value and/or direction), prediction accuracy, etc. For yet another example, if the type of prediction is selected as the trajectory special case type, the content of prediction may include but not limited to a time point, a trajectory special case type, coordinate points and/or area of the trajectory special case, prediction accuracy, etc.

(10) related information used to indicate reasons for a trajectory prediction request failure, herein the reasons include at least one of the following: a trajectory prediction failure, no prediction ability, no trajectory prediction ability and no sufficient data.

In this way, reference information is provided for the first node to make a decision for the UE about whether to handover, the decision of handover time, the selection of target nodes, etc., so as to reduce the situations of handover failures, handover ping-pong, too many candidate target nodes, etc.

It can be understood that (6) the requested content confirmation and (10) the information used to indicate the reasons for a trajectory prediction request failure included in the second message can be transmitted to the first node in a separate message to indicate whether the second node can predict the trajectory of the user equipment.

As an implementation, if the second node can't feedback information such as a trajectory prediction result to the first node according to the first message after receiving the first message transmitted by the first node, the second node transmits to the first node a third message, used to indicate information on whether the second node can predict the trajectory of the user equipment.

The third message may be, for example, but not limited to, a RETRIEVE UE CONTEXT RESPONSE message or a RETRIEVE UE CONTEXT FAILURE message of X2 or Xn. It can also be an SENB MODIFICATION REQUEST ACKNOWLEDGE message or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2. It can also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE of Xn. It can also be a PATH SWITCH REQUEST ACKNOWLEDGE message or a PATH SWITCH REQUEST FAILURE message of NG.

The third message may also be a newly defined X2 or Xn or NG message, for example.

The third message, for example may include one or more of the following:

(1) a UE identity, which is used to identify the UE for whom the trajectory prediction needs to be done.

The identity may include, for example, but not limited to, at least one of the following: NG-RAN node UE XnAP ID, Source NG-RAN node UE XnAP ID, MNG-RAN node UE XnAP ID, S-NG-RAN node UE XnAP ID, MeNB UE X2AP ID, SeNB UE X2AP ID, MeNB UE X2AP ID, SgNB UE X2AP ID, AMF UE NGAP ID, RAN UE NGAP ID, Source AMF UE NGAP ID.

(2) a first node identity, which is used to identify the first node.

The identity may include, for example, but not limited to, at least one of the following: Cell Global ID, Target Cell Global ID and Requested Target Cell ID.

(3) a second node identity, which is used to identify the second node.

The identity may include, for example, but not limited to, at least one of the following: Cell Global ID, Target Cell Global ID and Requested Target Cell ID.

(4) requested content confirmation, which is related information used to confirm whether the requested trajectory prediction content is predicted or not.

The requested content confirmation can be represented by a single bit. For example, a bit of 1 indicates that all the requested content can be predicted, and a bit of 0 indicates that the requested content cannot be predicted.

For example, the requested content confirmation can also confirm the prediction request content one by one in the form of bitmap. For example, each bit corresponds to a prediction content. For example, if the bit is 1, it means that the prediction trajectory information of the corresponding prediction content can be transmitted, while 0 means that the prediction trajectory information of the corresponding prediction content cannot be transmitted.

For example, the requested content confirmation may also be that a separate field indicates different prediction content confirmation.

(5) related information used to indicate reasons for a trajectory prediction request failure, for example, a trajectory prediction failure, no prediction ability, no trajectory prediction ability and no sufficient data.

The third message can be fedback to the first node when the second node can't predict the trajectory, so that the first node can know that the second node can't predict the trajectory according to the request of the first node, thus avoiding the first node from waiting for a long time.

The embodiment of the present disclosure also provides a method for supporting data collection and processing by wireless communication network, which includes:

The first node transmits a fourth message to the second node, which includes information about the requested reporting requirement of the data usage, so as to inform the second node of the requested reporting requirement of the data usage of the UE. In this disclosure, data usage can be used interchangeably with traffic without affecting the protection scope of this disclosure.

The fourth message may be, for example but not limited to, a gNB central unit control plane (gNB-CU-CP) E1 SETUP REQUEST message or a GNB-CU-CP CONFIGURATION UPDATE message or a BEARER CONTEXT SETUP REQUEST message or a BEARER CONTEXT MODIFICATION REQUEST message of E1. The fourth message may also be a newly defined E1 or Xn or X2 or NG message, for example.

The fourth message, for example may include one or more of the following:

(1) a UE identity, which is used to identify the UE for whom the data usage needs to be reported.

The identity may include, for example, but not limited to, at least one of the following: gNB-CU-CP UE E1AP ID, gNB-CU-UP UE E1AP ID.

(2) a first node identity, which is used to identify the node that transmits the request.

The identity may include, for example, but not limited to, at least one of the following: Cell Global ID, Target Cell Global ID and Requested Target Cell ID.

(3) a second node identity, which is used to identify the node receiving the request.

The identity may include, for example, but not limited to, at least one of the following: Cell Global ID, Target Cell Global ID and Requested Target Cell ID.

(4) requested reporting scope, which is related information used to indicate whether the requested reporting scope includes multi-radio dual connectivity (MR-DC).

The field can be represented by a single bit, for example. For example, a bit of 1 indicates that MR-DC is included and a bit of 0 indicates that MR-DC is not included.

(5) a requested type of data usage reporting, which is related information used to indicate the data usage information type requested to report, for example, it can include one or more of the following: uplink usage count, downlink usage count, etc.

(6) a requested reporting type, which is related information used to indicate a type requested to report.

The requested reporting type includes but is not limited to:

(a) an on-demand type: it only needs to be reported once according to the reporting requirements.

(b) a periodic type: it needs to reporting periodically according to the reporting interval.

(7) reporting registration request, which is related information used to indicate the start and/or end and/or add of reporting.

(8) a reporting interval, which is related information used to indicate the corresponding interval time when the reporting type is periodic reporting. This field can also be used to indicate whether the reporting type is periodic reporting at the same time. That is, if the transmission mode of data usage is the periodic reporting, the reporting interval of data usage is the interval indicated by the reporting interval; if the transmission mode of data usage is the on-demand reporting, the reporting interval is a default value, which can be, but not limited to, an all-zero field, or determined by implementation.

(9) a measurement interval, which is related information used to indicate a counting interval of the data usage type requested to report.

After receiving the fourth message, the second node needs to report the data usage of the UE to the first node according to the reporting requirement, so that the first node can obtain the data usage information of the UE in the second node at an appropriate time, so as to provide reference information for the first node to make decision of resource allocation, data usage prediction, selection for user plane and target node of handover, etc. for the UE, so as to improve the Quality of Service (QOS) performance of the UE and reduce situations such as handover failures and the like.

As another implementation, the second node can also transmit the data usage information of the user equipment in the second node to the first node according to its own situation, instead of transmitting it after receiving the fourth message.

The data usage information includes, but is not limited to, a DATA USAGE REPORT message, and may also be an MR-DC DATA USAGE REPORT message.

In this way, the data usage of the UE counted in the second node is provided to the first node, so that the first node can optimize resource allocation, predict data usage and the like for the UE.

The embodiment of the present disclosure also proposes a method for supporting data collection and processing by wireless communication network, which includes:

First, the first node transmits a fifth message to the second node, which includes related information for requesting data usage prediction of the user equipment, so as to inform the second node of the information related to the data usage prediction of the user equipment.

The fifth message may be, for example but not limited to, a GNB-CU-CP E1 SETUP REQUEST message or a GNB-CU-CP CONFIGURATION UPDATE message or a BEARER CONTEXT SETUP REQUEST message or a BEARER CONTEXT MODIFICATION REQUEST message of E1, it can also be a HANDOVER REQUEST ACKNOWLEDGE message or a RETRIEVE UE CONTEXT REQUEST message or a HANDOVER SUCCESS message of X2 or Xn; a SENB MODIFICATION REQUEST message or a SGNB MODIFICATION REQUEST message or a SENB MODIFICATION REQUIRED message or a SGNB MODIFICATION REQUIRED message of X2, or an S-NODE MODIFICATION REQUEST message or an S-NODE MODIFICATION REQUIRED message of Xn, it can also be a HANDOVER COMMAND message or a HANDOVER PREPARATION FAILURE message or a HANDOVER REQUEST ACKNOWLEDGE message or a HANDOVER NOTIFY message or a HANDOVER SUCCESS message or a PATH SWITCH REQUEST message of NG. The fifth message may also be a newly defined E1 or X2 or Xn or NG message, for example.

The fifth message, for example, may include one or more of the following:

(1) a UE identity, which is used to identify the UE for whom the data usage prediction needs to be done.

The identity may be one or more of the following: gNB-CU-CP UE EIAP ID, gNBCU-UP UE EIAP ID, NG-RAN node UE XnAP ID, Source NG-RAN node UE XnAP ID, M-NG-RAN node UE XnAP ID, S-NG-RAN node UE XnAP ID. MeNB UE X2AP ID. SeNB UE X2AP ID. MeNB UE X2AP ID. SgNB UE X2AP ID. AMF UE NGAP ID. RAN UE NGAP ID. Source AMF UE NGAP ID.

(2) a first node identity, which is used to identify the node that transmits the request.

The identity can be one or more of the following: Cell Global ID, Target Cell Global ID and Requested Target Cell ID, for example.

(3) a second node identity, which is used to identify the node receiving the request.

The identity can be one or more of the following: Cell Global ID, Target Cell Global ID and Requested Target Cell ID, for example.

(4) handover time of the requested user equipment, which is related information used to identify handover time of the requested user equipment.

This time can be, for example, relative time or absolute time.

(5) a prediction identity, which is used to identify whether the fifth message includes related information for requesting prediction or data usage prediction of the user equipment.

This field can be represented by a single bit. For example, 1 indicates that the request is a request for data usage prediction, and 0 indicates that the request is not a request for data usage prediction. Or 1 indicates that the request is a request for prediction, and 0 indicates that the request is not a request for prediction.

(6) a prediction registration request, which is related information used to indicate at least one of the start, end or add of a data usage prediction request.

(7) a time interval for the requested prediction result, which is related information used to indicate the requested time interval for the data usage prediction result.

The time interval for the requested prediction result can be represented by 2*n bits, for example, the first n bits represent the start time for data usage prediction results and the last n bits represent the end time for data usage prediction results, which can be relative time or absolute time.

The time interval for the requested prediction result can also be represented by a separate field, including one or more of the following:

(a) start time for prediction result, which is used to indicate the start time for data usage prediction results. The start time can be relative time or absolute time.

(b) end time for prediction result, which is used to indicate the end time for data usage prediction results. The end time may be relative time or absolute time.

(8) a reporting type of the requested prediction result, which is related information used to indicate whether the reporting of the requested data usage prediction result is one-time reporting or periodic reporting. The reporting type include but is not limited to: an on-demand type, a periodic type, etc.

(9) a reporting period of the requested prediction result, which is related information used to indicate a corresponding interval time when the reporting of the requested data usage prediction result is periodic reporting.

The reporting period can for example, also be the prediction time of the reported data. If there is no content in this field, it means that a one-time reporting is enough, and the prediction time for a one-time reporting is from the start time for prediction result to the end time for prediction result.

(10) reporting triggering conditions, which is related information used to indicate triggering conditions under which the reporting is needed.

Reporting is needed only when the prediction result or actual situation meets the reporting triggering conditions.

The triggering conditions under which the reporting is needed include, for example, at least one of the following: sudden increase of data usage, sudden drop of data usage, data usage exceeding a first predetermined threshold for a first preset time period, and data usage falling below a second predetermined threshold for a second preset time period.

(11) a type of the requested prediction, which is related information used to indicate a type of the requested data usage prediction. The type of the requested prediction includes, for example, but not limited to: data usage prediction, data usage special case prediction, etc.

(12) the requested content of prediction, which is related information used to indicate parameters of the requested data usage prediction.

The parameters include at least one of the following: a time point for which the prediction is requested, uplink data usage prediction, downlink data usage prediction, a data usage special case type, data usage special case time and/or time interval used to indicate the time information when a data usage special case occurs, and prediction accuracy, herein the data usage special case type includes at least one of the following: sudden increase of data usage, sudden drop of data usage, data usage exceeding a first predetermined threshold for a first preset time period, and data usage falling below a second predetermined threshold for a second preset time period.

As an implementation, the requested content of the prediction may be related to the type of the requested prediction, for example. For example, if the type of the requested prediction is data usage prediction, the requested content of the prediction includes but is not limited to a time point, uplink data usage prediction, downlink data usage prediction, prediction accuracy, etc. If the type of the requested prediction is the data usage special case type, the content of the requested prediction includes but is not limited to a time point, a data usage special case type, data usage special case time and/or time interval, prediction accuracy, etc.

Then, after receiving the fifth message, the second node transmits a sixth message including information related to data usage prediction of the user equipment to the first node, so that the first node can acquire the information related to the data usage prediction of the user equipment.

As another implementation, the second node can also transmit the sixth message including information related to data usage prediction of the user equipment to the first node according to its own situation, instead of transmitting the sixth message after receiving the fifth message.

The sixth message may be, for example but not limited to, a DATA USAGE REPORT message or a MR-DC DATA USAGE REPORT message or a BEARER CONTEXT MODIFICATION RESPONSE message or a BEARER CONTEXT SETUP REQUEST message of E1. It may also be a HANDOVER REQUEST message, a RETRIEVE UE CONTEXT RESPONSE message or a RETRIEVE UE CONTEXT FAILURE message of X2 or Xn. It can also be an SENB MODIFICATION REQUEST ACKNOWLEDGE message or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2. It can also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE of Xn. It can also be a PATH SWITCH REQUEST ACKNOWLEDGE message or a PATH SWITCH REQUEST FAILURE message of NG. The sixth message may also be a newly defined E1 or X2 or Xn or NG message, for example.

The sixth message, for example, may include one or more of the following:

(1) a UE identity, which is used to identify the UE for whom the data usage prediction needs to be done.

The identity may be one or more of the following: gNB-CU-CP UE E1AP ID, gNBCU-UP UE E1AP ID, NG-RAN node UE XnAP ID, Source NG-RAN node UE XnAP ID, M-NG-RAN node UE XnAP ID, S-NG-RAN node UE XnAP ID. MeNB UE X2AP ID. SeNB UE X2AP ID. MeNB UE X2AP ID. SgNB UE X2AP ID. AMF UE NGAP ID. RAN UE NGAP ID. Source AMF UE NGAP ID.

(2) a first node identity, which is used to identify the first node.

The identity can be one or more of the following: Cell Global ID, Target Cell Global ID and Requested Target Cell ID, for example.

(3) a second node identity, which is used to identify the second node.

The identity can be one or more of the following: Cell Global ID, Target Cell Global ID and Requested Target Cell ID, for example.

(4) user equipment handover time, which is related information used to identify handover time of the user equipment.

The user equipment handover time can be relative time or absolute time.

(5) requested content confirmation, which is related information used to confirm whether the content of the requested data usage prediction is predicted or not.

The requested content confirmation can be represented by a single bit. For example, a bit of 1 indicates that all the requested content can be predicted, and a bit of 0 indicates that the requested content cannot be predicted.

For example, the requested content confirmation can also confirm the prediction request content one by one in the form of bitmap. For example, each bit corresponds to a prediction content. For example, if the bit is 1, it means that the data usage prediction information of the corresponding prediction content can be transmitted, while 0 means that the data usage prediction information of the corresponding prediction content cannot be transmitted.

For example, the requested content confirmation may also be that a separate field indicates different prediction content confirmation.

(6) a prediction identity of prediction content, which is related information used to indicate whether the data usage information is the prediction content.

The prediction identity field of prediction content can be expressed by a single bit. For example, a value of 1 indicates that the information is the prediction content, and 0 indicates that the information is the actual state content.

(7) a time interval for prediction result, which is related information used to indicate a time interval for data usage prediction result;

The time interval for prediction can be represented by 2*n bits, for example, the first n bits represent the start time for data usage prediction results and the last n bits represent the end time data usage prediction result, which can be relative time or absolute time.

The time interval for prediction may also be represented by a separate field, for example, and may include one or more of the following:

(a) start time for prediction result, which is used to indicate the start time for data usage prediction result. The start time can be relative time or absolute time.

(b) end time for prediction result, which is used to indicate the end time for data usage prediction result. The end time may be relative time or absolute time.

(8) a type of prediction, which is related information used to indicate a type of the performed data usage prediction; The type of the prediction includes, for example, but not limited to: data usage prediction, data usage special case prediction, etc.

(9) content of prediction, which is related information used to indicate parameters of the performed data usage prediction.

The parameters include at least one of the following: a time point, uplink data usage prediction, downlink data usage prediction, a data usage special case type, data usage special case time and/or time interval used to indicate the time information whena data usage special case occurs, and prediction accuracy, herein, the data usage special case type includes at least one of the following: sudden increase of data usage, sudden drop of data usage, data usage exceeding a first predetermined threshold for a first preset time period, and data usage falling below a second predetermined threshold for a second preset time period.

(11) related information used to indicate reasons for a data usage request failure, herein, the reasons include at least one of the following: a data usage prediction failure, no prediction ability, no data usage prediction ability and no sufficient data.

As an implementation, the content of the prediction may be related to the type of the prediction, for example. For example, if the type of the prediction is data usage prediction, the content of the prediction includes but is not limited to a time point, uplink data usage prediction, downlink data usage prediction, prediction accuracy, etc. If the type of the prediction is the data usage special case type, the content of the prediction includes but is not limited to a time point, a data usage special case type, data usage special case time and/or time interval, prediction accuracy, etc.

In this way, reference information is provided for the first node to make resource allocation and handover target node selection for the UE, so as to improve the QoS performance of the UE and reduce handover failures and other cases.

It can be understood that (5) the requested content confirmation and (11) the information used to indicate reasons for a data usage request failure included in the sixth message can be transmitted to the first node in a separate message to indicate whether the second node can predict the data usage of the user equipment.

As an implementation, after receiving the fifth message transmitted by the first node, if the second node can't feedback information such as a data usage prediction result to the first node according to the fifth message, the second node transmits to the first node a seventh message, used to indicate information on whether the second node can predict the data usage of the user equipment.

The seventh message may be, for example but not limited to, a DATA USAGE REPORT message or a MR-DC DATA USAGE REPORT message or a BEARER CONTEXT MODIFICATION RESPONSE message of E1. It may also be a RETRIEVE UE CONTEXT RESPONSE message or a RETRIEVE UE CONTEXT FAILURE message of X2 or Xn. It can also be an SENB MODIFICATION REQUEST ACKNOWLEDGE message or an SENB MODIFICATION REQUEST REJECT message or an SGNB MODIFICATION REQUEST ACKNOWLEDGE message or an SGNB MODIFICATION REQUEST REJECT message or an SENB MODIFICATION CONFIRM message or an SENB MODIFICATION REFUSE message or an SGNB MODIFICATION CONFIRM message or an SGNB MODIFICATION REFUSE message of X2. It can also be an S-NODE MODIFICATION REQUEST ACKNOWLEDGE message or an S-NODE MODIFICATION REQUEST REJECT message or an S-NODE MODIFICATION CONFIRM message or an S-NODE MODIFICATION REFUSE of Xn. It can also be a PATH SWITCH REQUEST ACKNOWLEDGE message or a PATH SWITCH REQUEST FAILURE message of NG. The seventh message may also be a newly defined E1 or X2 or Xn or NG message, for example.

The seventh message, for example, may include one or more of the following:

(1) a UE identity, which is used to identify the UE for whom the data usage prediction needs to be done.

The identity may be one or more of the following: NG-RAN node UE XnAP ID, Source NG-RAN node UE XnAP ID, M-NG-RAN node UE XnAP ID, S-NG-RAN node UE XnAP ID, MeNB UE X2AP ID, SeNB UE X2AP ID, MeNB UE X2AP ID, SgNB UE X2AP ID, AMF UE NGAP ID, RAN UE NGAP ID, Source AMF UE NGAP ID.

(2) a first node identity, which is used to identify the first node.

The identity can be one or more of the following: Cell Global ID, Target Cell Global ID and Requested Target Cell ID, for example.

(3) a second node identity, which is used to identify the second node.

The identity can be one or more of the following: Cell Global ID, Target Cell Global ID and Requested Target Cell ID, for example.

(4) requested content confirmation, which is related information used to confirm whether the content of the requested data usage prediction is predicted or not.

For example, the requested content confirmation can be represented by a single bit. For example, a bit of 1 indicates that all the requested content can be predicted, and a bit of 0 indicates that the requested content cannot be predicted.

For example, the requested content confirmation can also confirm the prediction request content one by one in the form of bitmap. For example, cach bit corresponds to a prediction content. For example, if the bit is 1, it means that the data usage prediction information of the corresponding prediction content can be transmitted, while 0 means that the data usage prediction information of the corresponding prediction content cannot be transmitted.

For example, the requested content confirmation may also be that a separate field indicates different prediction content confirmation.

(5) related information used to indicate reasons for a data usage request failure, such as a data usage prediction failure, no prediction ability, no data usage prediction ability, no sufficient data, etc.

The seventh message can be fedback to the first node when the second node can't predict the data usage, so that the first node can know that the second node can't predict the data usage according to the request of the first node, thus avoiding the first node from waiting for a long time.

The embodiment of the present disclosure also provides a method for supporting data collection and processing by wireless communication network, which includes:
the first node transmits an eighth message to the second node, which includes related information for requesting at least one of achievable quality of service prediction, achievable quality of service reporting, quality of service prediction, quality of service reporting, achievable quality of experience prediction, achievable quality of experience reporting, quality of experience prediction, quality of experience reporting of the second node and/or a UE, so as to request the second node to perform at least one of the achievable quality of service prediction, information collection of achievable quality of service, quality of service prediction, information collection of quality of service, achievable quality of experience prediction, information collection of achievable quality of experience, quality of experience prediction, information collection of quality of experience on the second node and/or the UE and feedback related information.

The eighth message may be, for example, but not limited to, a RESOURCE STATUS REQUEST message of X2 or Xn or F1 or E1, may also be an EN-DC RESOURCE STATUS REQUEST message or EN-DC X2 SETUP REQUEST message or EN-DC CONFIGURATION UPDATE message or SGNB ADDITION REQUEST message of X2, may also be an XN SETUP REQUEST message, an NG-RAN NODE CONFIGURATION UPDATE message, or S-NODE ADDITION REQUEST message or an S-NODE ADDITION REQUEST message or an S-NODE MODIFICATION REQUIRED message of Xn, or may also be a gNB Central Unit (gNB-CU) configuration update (GNB-CU CONFIGURATION UPDATE) message of F1, may also be a GNB-CU-CP E1 SETUP REQUEST message or a GNB-CU-CP CONFIGURATION UPDATE message or a BEARER CONTEXT SETUP REQUEST message or a BEARER CONTEXT MODIFICATION REQUEST message of E1. The eighth message may also be a newly defined message of X2 or Xn or F1 or E1, for example.

The eighth message, for example, may include one or more of the following:

(1) a first node identity, which is used to identify the node that transmits the request.

The identity may be one or more of the following, for example: eNB Measurement ID, NG-RAN node Measurement ID, gNB-CU Measurement ID, gNB-CU-CP Measurement ID.

(2) a second node identity, which is used to identify the node receiving the request.

The identity may be one or more of the following, for example: eNB Measurement ID, en-gNB Measurement ID, NG-RAN node Measurement ID, gNB-DU Measurement ID, gNB-CU-UP Measurement ID.

(3) a prediction identity, which is used to identify whether the eighth message includes related information for requesting prediction or achievable quality of service prediction and/or quality of service prediction and/or achievable quality of experience prediction and/or quality of experience prediction of the second node and/or the UE;

This field can be represented by a single bit. For example, 1 indicates that the request is a request for achievable QoS prediction, and 0 indicates that the request is not a request for achievable QoS prediction. Or 1 indicates that the request is a request for prediction, and 0 indicates that the request is not a request for prediction; 1 indicates that the request is a request for QoS prediction, and 0 indicates that the request is not a request for QoS prediction; or 1 indicates that the request is a request for achievable QoE prediction, and 0 indicates that the request is not a request for achievable QoE prediction; or 1 indicates that the request is a request for QoE prediction, and 0 indicates that the request is not a request for QoE prediction; or 1 indicates that the request is a request for achievable QoS prediction, and 0 indicates that the request is a request for achievable QoE prediction; or 1 indicates that the request is a request for achievable QoE prediction, and 0 indicates that the request is a request for achievable QoS prediction;

(4) a prediction registration request, which is related information used to indicate at least one of the start, end or add of an achievable quality of service prediction request and/or a quality of service prediction request and/or an achievable quality of experience prediction request and/or a quality of experience prediction request and/or an achievable quality of experience prediction request;

(5) a prediction type, which is related information used to indicate a type of the requested achievable quality of service prediction, such as resource prediction, QoS prediction, achievable 5th generation quality of service identifier (5QI) type, specific achievable service quality parameters etc. It can also be related information used to indicate the type of requested achievable quality of experience prediction, such as specific RAN visible QoE parameters, specific QoE parameters, etc. It can also be related information used to indicate the type of requested prediction, such as achievable quality of service prediction, achievable quality of experience prediction, etc., wherein the achievable quality of service prediction can include QoS prediction, the achievable fifth generation quality of service identifier (5QI) type, specific achievable quality of service parameters, etc., and the achievable quality of experience prediction can include specific RAN visible QoE parameters, specific QoE parameters, RAN visible QoE evaluation values and QoE evaluation values, etc.

(6) a prediction time interval, which is related information used to indicate a time interval for prediction of the requested achievable quality of service and/or quality of service and/or achievable quality of experience and/or quality of experience;

The prediction time interval can be represented by 2*n bits, for example, the first n bits represent the start time for prediction of achievable quality of service and/or quality of service and/or achievable quality of experience and/or quality of experience, and the last n bits represent the end time for prediction of achievable quality of service and/or quality of service and/or achievable quality of experience and/or quality of experience, which can be relative time or absolute time.

The prediction time interval may also be represented by a separate field, for example, and may include one or more of the following:

(a) start time for prediction, which is used to indicate the start time for achievable quality of service prediction and/or quality of service prediction and/or achievable quality of experience prediction and/or quality of experience prediction. The start time can be relative time or absolute time.

(b) end time for prediction, which is used to indicate the end time for achievable quality of service prediction and/or quality of service prediction and/or achievable quality of experience prediction and/or quality of experience prediction. The end time may be relative time or absolute time.

(7) a prediction result reporting type, which is related information used to indicate whether the reporting of the requested achievable quality of service prediction result and/or quality of service prediction result and/or achievable quality of experience prediction result and/or quality of experience prediction result is one-time reporting or periodic reporting;

The prediction result reporting type may include, but are not limited to, an on-demand type, a periodic type, etc.

(8) a reporting period of prediction result, which is related information used to indicate a corresponding interval time when the reporting of the requested achievable quality of service prediction result and/or quality of service prediction result and/or achievable quality of experience prediction result and/or quality of experience prediction result is periodic reporting.

The prediction result reporting period can also be the prediction time of the reported data. If there is no content in this field, it means that a one-time reporting is enough, and the prediction time of a one-time reporting is from the start time for prediction result to the end time for prediction result.

(9) reporting triggering conditions, which is related information used to indicate triggering conditions under which the reporting is needed.

Report is needed only when the prediction result or actual situation meets the reporting triggering conditions, for example reporting is needed only in the case of change of situation of supportable QoS, change of achievable QoS, change of situation of supportable QoE, change of situation of supportable RAN visible QoE, change of situation of QoS, change of situation of QoE, change of situation of RAN visible QoE, etc.

(10) a prediction type, which is related information used to indicate a type of the requested achievable quality of service prediction and/or achievable quality of experience prediction;

The type may include, for example, an achievable fifth generation quality of service identifier (5QI) type or a particular parameter of achievable quality of service or specific RAN visible QoE parameters or specific QoE parameters or specific QoE evaluation value prediction, etc.

(11) prediction content, which is related information used to indicate parameters of the requested achievable quality of service prediction and/or quality of service prediction and/or achievable quality of experience prediction and/or quality of experience prediction.

For example, the parameters may include at least one of the following: the achievable highest packet loss rate, the achievable lowest packet loss rate, the achievable maximum time delay, the achievable lowest time delay, the achievable highest throughput, the achievable lowest throughput, the achievable highest data rate, the achievable lowest data rate, the achievable fifth generation quality of service identifier (5QI) type, the prediction accuracy, the QoS parameters, the QoS evaluation values, the RAN visible QoE parameters, the achievable RAN visible QoE parameters, the QoE parameters, the achievable QoE parameters, the QoE evaluation values.

(12) an identity of the object to which the requested information belongs, which is used to indicate the entity to which the requested information to be fed-back belongs, for example, it may include a UE, a node. If the identity of the object to which the requested information belongs is a UE, related information of the UE is requested to be fed-back. If the identity of the object to which the requested information belongs is a node, related information of the node is requested to be fed-back.

(13) a UE identity, which is used to identify the identity of the belonged object UE when the object of the requested information is the UE.

(14) requested counting and/or prediction granularity, which is used to indicate the granularity of the requested counting and/or prediction. For example, it may include one or more of the followings: UE, QoS flow, QoS level, Data Radio Bearer, slice, cell, node, service, area, operator, etc.

(15) a identity and/or identity list of range for the requested counting and/or prediction, which is used to indicate the identity and/or identity list of the range for the requested counting and/or prediction. For example, it may include identities of one or more of the followings: UE, QoS flow, QoS level, Data Radio Bearer, slice, cell, node, service, area, operator, etc. The identity of the slice can be single network slice selection assistance information (S-NSSAI). The identity of the cell may be a Physical-layer Cell identity. The identity of the operator may be a Public Land Mobile Network ID (PLMN ID). The identity of QoS level may be a mapped 5G QoS Identifier (5QI) or a QoS Class Identifier (QCI).

(16) a registration request, which is used to indicate the related information of at least one of the start, end or addition of the request.

(17) a request type, which is used to indicate the requested reporting and/or prediction type, for example, it may include one or more of the followings: an achievable quality of service prediction request, an achievable quality of service reporting request, a quality of service prediction request, a quality of service reporting request, an achievable quality of experience prediction request, an achievable quality of experience reporting request a quality of experience reporting request and a quality of experience prediction request.

(18) a reporting time interval, which is used to indicate the time interval in which the requested reporting content and/or prediction content need to be fed-back.

The reporting time interval can be represented by 2*n bits, for example, the first n bits represent the start time of reporting and the last n bits represent the end time of reporting, which can be relative time or absolute time.

For example, the reporting time interval can also be represented by a separate field, which can include one or more of the followings:

(a) reporting start time: which is used to indicate the reporting start time of the requested reporting content and/or prediction content. The start time can be relative time or absolute time.

(b) reporting end time: which is used to indicate the reporting end time of the requested reporting content and/or prediction content. The end time can be relative time or absolute time.

(19) a reporting type, which is related information used to indicate whether the reporting type of the requested reporting content and/or prediction content is one-time reporting, periodic reporting or event-triggered reporting.

The reporting type of results can include, but not limited to, on-demand type, periodic type, event-triggered type, etc.

(20) a result reporting period, which is related information used to indicate corresponding interval time when the requested reporting content and/or prediction content is periodic reporting.

The result reporting period can also be the prediction time for the prediction data to be reported this time. If the content of this field is absent, it means that one-time reporting is enough, and the prediction time for one-time reporting is from the prediction start time to the prediction end time.

(21) requested reporting content, which is used to indicate the requested parameter information to be reported. It may include one or more of the followings: an achievable fifth-generation quality of service identifier (5QI) type, an achievable quality of service parameter, an achievable QoS evaluation value, a quality of service parameter, a QoS evaluation value, an achievable QoE parameter, an achievable QoE evaluation value, an achievable RAN visible QoE parameter, an achievable RAN visible QoE evaluation value, a QoE parameter, a RAN visible QoE parameter, a QoE evaluation value, a RAN visible QoE evaluation value, a predicted value of the achievable fifth generation quality of service identifier (5QI) type, a predicted value of the achievable quality of service parameter, a predicted value of the achievable QoS evaluation value, a predicted value of the quality of service parameter, a predicted value of the QoS evaluation value, a predicted value of the achievable QoE parameter, a predicted value of the achievable QoE evaluation value, a predicted value of the achievable RAN visible QoE parameter, a predicted value of the achievable RAN visible QoE evaluation value, a predicted value of the QoE parameter, a predicted value of RAN visible QoE parameter, a predicted value of the QoE evaluation value, a predicted value of RAN visible QoE evaluation value, and prediction accuracy, etc. As an implementation, the prediction content may be related to the prediction type, for example.

For example, if the prediction type is an achievable 5QI prediction type, the prediction content may include, but not limited to, time point, an achievable 5QI type, prediction accuracy, etc. If the prediction type is the specific achievable QoS parameter type, the prediction content may include, but is not limited to, the time point, the achievable highest packet loss rate, the achievable lowest packet loss rate, the achievable maximum delay, the achievable lowest delay, the achievable highest throughput, the achievable lowest throughput, the achievable highest data rate, the achievable lowest data rate, the achievable 5QI type, the prediction accuracy, etc. If the prediction type is specific RAN visible QoE parameter prediction, the predicted content may include, for example, the achievable longest and/or shortest Round-trip time, the achievable longest and/or shortest Jitter duration, the achievable longest and/or shortest Corruption duration, the achievable maximum and/or the minimum average throughput, the achievable longest and/or shortest initial playout delay, the achievable maximum and/or minimum range of device information, the achievable maximum and/or minimum rendered viewports, the achievable maximum and/or minimum range of codec information, the achievable maximum and/or minimum buffer level, the achievable maximum and/or minimum range of representation switch events, the achievable maximum and/or minimum range of play List, the achievable maximum and/or minimum range of media presentation description information (MPD), the achievable maximum and/or minimum range of interactivity summary, the achievable maximum and/or minimum range of interactivity event list, prediction accuracy, etc.; If the prediction type is a specific QoE parameter, the predicted content may include, for example, Round-trip time, Jitter duration, Corruption duration, Average throughput, Initial playout delay, Device information, Rendered viewports, Codec information, Buffer level, Presentation switch events, Play List, Media presentation description information (MPD information), Interactivity Summary, Interactivity Event List and prediction accuracy. If the prediction type is QoE evaluation value prediction, the prediction content may include, for example, the prediction value of QoE evaluation value, the prediction value of QoE MOS value, prediction accuracy, etc.

As an implementation, the requested reporting content may be related to the request type, for example. For example, if the request type is an achievable quality of service prediction request, the requested reporting content is the achievable fifth-generation quality of service identifier (5QI) type prediction value, the achievable quality of service parameter prediction value, the achievable QoS evaluation value prediction value and prediction accuracy; if the request type is an achievable quality of service reporting request, the requested reporting content is the achievable fifth-generation quality of service identifier (5QI) type, the achievable quality of service parameter, the achievable QoS evaluation value; if the request type is a quality of service prediction request, the requested reporting content is the quality of service parameter prediction value, the QoS evaluation value prediction value and prediction accuracy, etc. If the request type is a quality of service reporting request, the requested reporting content is the quality of service parameter, the QoS evaluation value, etc. If the request type is an achievable quality of experience prediction request, the requested reporting content is the achievable RAN visible QoE parameter prediction value, the achievable QoE parameter prediction value, the achievable QoE evaluation value prediction value, the achievable RAN visible QoE evaluation value prediction value, the prediction accuracy, etc. If the request type is an achievable quality of experience reporting request, the requested reporting content includes the achievable RAN visible QoE parameters, the achievable QoE parameters, the achievable QoE evaluation value, the achievable RAN visible QoE evaluation value, etc. If the request type is a quality of experience prediction request, the requested reporting content is the RAN visible QoE parameter prediction value, the QoE parameter prediction value, the QoE evaluation value prediction value, the RAN visible QoE evaluation value prediction value, the prediction accuracy, etc. If the request type is a quality of experience reporting request, the requested reporting content is the RAN visible QoE parameter, the QoE parameter, the QoE evaluation value, the RAN visible QoE evaluation value, etc.

If the requested counting and/or prediction granularity is UE, QoS flow, QoS level, Data Radio Bearer, slice, cell, node, service, area, and operator, the requested reporting content can be the average value of a certain period of time or the recorded value of a certain time point at that granularity.

Then, after receiving the eighth message, the second node performs the achievable quality of service prediction, and/or information collection of achievable quality of service, and/or quality of service prediction, and/or information collection of quality of service, and/or achievable quality of experience prediction, and/or information collection of achievable quality of experience, and/or quality of experience prediction, and/or collection of quality of experience, according to the eighth message, and transmits the tenth message including information related to at least one of the achievable quality of service prediction, achievable quality of service, quality of service prediction, quality of service, achievable quality of experience prediction, achievable quality of experience, quality of experience prediction, quality of experience of the second node and/or the UE to the first node, so that the first node can acquire the information such as the result of the achievable quality of service prediction, related information of the achievable quality of service, the result of the quality of service prediction, related information of the quality of service, the result of the achievable quality of experience prediction, related information of the achievable quality of experience, the result of the quality of experience prediction, related information of the quality of experience of the second node.

As another implementation, the second node can also transmit the tenth message including information related to at least one of the achievable quality of service prediction, achievable quality of service, quality of service prediction, quality of service, achievable quality of experience prediction, achievable quality of experience, quality of experience prediction, quality of experience of the second node and/or the UE to the first node according to its own situation, for example, the change of achievable QoS, change of situation of supportable QoE, change of situation of supportable RAN visible QoE, change of situation of QoS, change of situation of QoE, change of situation of RAN visible QoE, etc., instead of transmitting the tenth message after receiving the eighth message.

The tenth message may be, for example but not limited to, a RESOURCE STATUS UPDATE message or a RESOURCE STATUS RESPONSE message of X2 or Xn or F1 or E1, may also be an EN-DC RESOURCE STATUS UPDATE message or an EN-DC RESOURCE STATUS RESPONSE message of X2, may also be an NG-RAN NODE CONFIGURATION UPDATE message of Xn, may also be a GNB-CU-UP CONFIGURATION UPDATE message of E1, or may also be a GNB-DU CONFIGURATION UPDATE message of F1. The tenth message may also be a newly defined message of X2 or Xn or F1 or E1, for example.

The tenth message, for example, may include one or more of the following:

(1) a first node identity, which is used to identify the first node.

The identity may be one or more of the following: eNB Measurement ID, NG-RAN node Measurement ID, gNB-CU Measurement ID, gNB-CU-CP Measurement ID.

(2) a second node identity, which is used to identify the second node.

The identity may be one or more of the following: eNB Measurement ID, cn-gNB Measurement ID, NG-RAN node Measurement ID, gNB-DU Measurement ID, gNBCU-UP Measurement ID.

(3) requested content confirmation, which is related information used to confirm at least one of whether the content of the requested achievable quality of service prediction is predicted or not, whether the achievable quality of service can be reported, whether the content of quality of service prediction is predicted, whether the quality of service can be reported, whether the content of achievable quality of experience prediction is predicted, whether the achievable quality of experience can be reported, whether the content of quality of experience prediction is predicted and whether the quality of experience can be reported;

The requested content confirmation can be a single bit representation. For example, a bit of 1 indicates that all the requested content can be predicted, and a bit of 0 indicates that the requested content cannot be predicted.

The requested content confirmation can be a single bit representation, for example. For example, a bit of 1 indicates that all the requested content can be reported, and a bit of 0 indicates that the requested content cannot be reported.

For example, the requested content confirmation can also confirm the prediction request content one by one in the form of bitmap. For example, cach bit corresponds to a prediction content. For example, if the bit is 1, it means that the prediction achievable QoS information of the corresponding prediction content can be transmitted, while 0 means that the prediction achievable QoSinformation of the corresponding prediction content cannot be transmitted. For example, when the bit is 1, it means that the corresponding content can be transmitted, and 0 means that the corresponding content cannot be transmitted.

For example, the requested content confirmation can also confirm the request content one by one in the form of bitmap. For example, cach bit corresponds to a content. For example, if the bit is 1, it means that the corresponding content can be transmitted, while 0 means that the corresponding content cannot be transmitted. For example, when the bit is 1, it means that the corresponding content can be transmitted, and 0 means that the corresponding content cannot be transmitted.

For example, the requested content confirmation may also be that a separate field indicates different prediction content confirmation. The requested content confirmation may also be that a separate field indicates different content confirmation.

(4) a prediction identity of prediction content, which is related information used to indicate whether achievable quality of service information, quality of service information, achievable quality of experience information, quality of experience information is the prediction content or not.

The prediction identity field of prediction content can be expressed by a single bit. For example, a value of 1 indicates that the information is the prediction content, and 0 indicates that the information is the actual state content.

(5) a prediction interval of prediction content, which is used to indicate the related information of the time interval for the achievable quality of service prediction, related information of the time interval for quality of service prediction, related information of the time interval for achievable quality of experience information prediction, related information of the time interval for quality of experience information prediction;

The prediction interval of prediction content can be represented by 2*n bits, for example, the first n bits represent the start time for achievable quality of service prediction and/or quality of service prediction and/or achievable quality of experience prediction and/or quality of experience prediction, and the last n bits represent the end time for achievable quality of service prediction and/or quality of service prediction and/or achievable quality of experience prediction and/or quality of experience prediction, which can be relative time or absolute time.

(a) start time for prediction content, which is used to represent the start time for the achievable QoS prediction and/or quality of service and/or achievable quality of experience and/or quality of experience. The start time can be relative time or absolute time.

(b) end time for prediction content, which is used to indicate the end time for achievable QoS prediction and/or quality of service and/or achievable quality of experience and/or quality of experience. The end time may be relative time or absolute time.

(6) achievable quality of service parameters, which are related information used to indicate parameters of achievable quality of service prediction;

The parameters include at least one of the following: a time point, the achievable highest packet loss rate, the achievable lowest packet loss rate, the achievable maximum time delay, the achievable lowest time delay, the achievable highest throughput, the achievable lowest throughput, the achievable highest data rate, the achievable lowest data rate, the achievable fifth generation quality of service identifier (5QI) type, and the prediction accuracy.

(7) related information used to indicate reasons for request failure of an achievable quality of service prediction and/or achievable quality of service reporting and/or quality of service prediction and/or quality of service reporting and/or achievable quality of experience prediction and/or achievable quality of experience reporting and/or quality of experience prediction and/or quality of experience reporting.

The reasons include at least one of the followings: achievable quality of service prediction failure, no prediction ability, no achievable quality of service prediction ability, no sufficient data, no achievable quality of service information, quality of service prediction failure, no quality of experience prediction ability, no quality of service information, achievable QoE prediction failure, no achievable QoE information, QoE prediction failure, no QoE information, etc.

(8) a UE identity, used to identify the object UE to which the information belongs.

(9) reporting content, used to indicate the reported parameter information. It may include one or more of the followings: an achievable fifth-generation quality of service identifier (5QI) type, an achievable quality of service parameter, an achievable QoS evaluation value, a quality of service parameter, a QoS evaluation value, an achievable QoE parameter, an achievable QoE evaluation value, an achievable RAN visible QoE parameter, an achievable RAN visible QoE evaluation value, a QoE parameter, a RAN visible QoE parameter, a QoE evaluation value, a RAN visible QoE evaluation value, a predicted value of the achievable fifth generation quality of service identifier (5QI) type, a predicted value of the achievable quality of service parameter, a predicted value of the achievable QoS evaluation value, a predicted value of the quality of service parameter, a predicted value of the QoS evaluation value, a predicted value of the achievable QoE parameter, a predicted value of the achievable QoE evaluation value, a predicted value of the achievable RAN visible QoE parameter, a predicted value of the achievable RAN visible QoE evaluation value, a predicted value of the QoE parameter, a predicted value of the RAN visible QoE parameter, a predicted value of the QoE evaluation value, a predicted value of the RAN visible QoE evaluation value, and prediction accuracy, etc.

(10) triggering event of reporting, used to indicate the triggering event of the reporting at this time. It may include one or more of the followings: change of situation of supportable QoS, change of achievable QoS, change of situation of supportable QoE, change of situation of supportable RAN visible QoE, change of situation of QoS, change of situation of QoE, change of situation of RAN visible QoE, etc.

(11) counting and/or prediction granularity for the reported parameters, used to indicate the granularity of the counting and/or prediction for the reported parameters. For example, it may include one or more of the followings: UE, QoS flow, QoS level, Data Radio Bearer, slice, cell, node, service, area, and operator, etc.

(12) the identity and/or identity list of the range for reported counting and/or prediction, used to indicate the identity and/or identity list of the range for the reported counting and/or prediction. For example, it may include one or more of the followings: UE, QoS flow, QoS level, Data Radio Bearer, slice, cell, node, service, area, and operator, etc. The identity of the slice can be single network slice selection assistance information (S-NSSAI). The identity of the cell may be a Physical-layer Cell identity. The identity of the operator may be a Public Land Mobile Network ID (PLMN ID). The identity of QoS level may be a mapped 5G QoS Identifier (5QI) or a QoS Class Identifier (QCI). In this way, reference information is provided for the first node to do the decision of the handover target node selection, energy saving, load balancing and so on, so as to ensure the QoS performance after UE handover, the performance after load migration, the performance after the implementation of the energy-saving strategy and avoid ping-pong of energy-saving switch.

When the requested counting and/or prediction granularity in the eighth message and/or the counting and/or prediction granularity of the reported parameters in the tenth message is UE, QoS flow, QoS level, Data Radio Bearer, slice, cell, node, service, area, and operator, the reporting content can be the average value of a certain period of time or the recorded value of a certain time point at that granularity.

It can be understood that (3) the request content confirmation and (7) the reason used to indicate request failure for the achievable quality of service prediction and/or achievable quality of service reporting and/or quality of service prediction and/or quality of service reporting and/or achievable quality of experience prediction and/or achievable quality of experience reporting and/or quality of experience prediction and/or quality of experience reporting and/or (8) the UE used to indicate to whom the information belongs included in the tenth message can be transmitted to the first node in a single message to indicate whether the second node can perform the achievable quality of service prediction and/or achievable quality of service reporting and/or quality of service prediction and/or quality of service reporting and/or achievable quality of experience prediction and/or achievable quality of experience reporting and/or quality of experience prediction and/or quality of experience reporting with respect to the second node and/or the UE.

As an implementation, if the second node can't feedback information such as the achievable quality of service prediction result and/or achievable quality of service and/or quality of service prediction result and/or quality of service and/or achievable quality of experience prediction result and/or achievable quality of experience and/or quality of experience prediction result and/or quality of experience to the first node according to the eighth message after receiving the eighth message transmitted by the first node, the second node transmits the ninth message to the first node to indicate whether the second node can perform the achievable quality of service prediction and/or achievable quality of service reporting and/or quality of service prediction and/or quality of service reporting and/or achievable quality of experience prediction and/or achievable quality of experience reporting and/or quality of experience prediction and/or quality of experience reporting with respect to the second node and/or the UE.

The ninth message may be, for example but not limited to, a RESOURCE STATUS RESPONSE message or a RESOURCE STATUS FAILURE message or a RESOURCE STATUS UPDATE message of X2 or Xn or F1 or E1, may also be an EN-DC RESOURCE STATUS RESPONSE message or an EN-DC RESOURCE STATUS FAILURE message of X2 or an EN-DC RESOURCE STATUS UPDATE message or an EN-DC X2 SETUP RESPONSE message or an EN-DC X2 SETUP FAILURE message or an EN-DC CONFIGURATION UPDATE message or an EN-DC CONFIGURATION UPDATE ACKNOWLEDGE message or an SGNB ADDITION REQUEST ACKNOWLEDGE message of X2, or may also be an XN SETUP RESPONSE message or an NG-RAN NODE CONFIGURATION UPDATE message or an NG-RAN NODE CONFIGURATION UPDATE ACKNOWLEDGE message or S-NODE ADDITION REQUEST message or an S-NODE ADDITION REQUEST ACKNOWLEDGE message or an S-NODE MODIFICATION REQUEST ACKNOWLEDGE message or an S-NODE MODIFICATION REQUEST REJECT message or an S-NODE MODIFICATION CONFIRM message or of Xn, or may also be a GNB-CU CONFIGURATION UPDATE ACKNOWLEDGE message or a gNB Distributed Unit (gNB-DU) configuration update (GNB-DU CONFIGURATION UPDATE) message of F1, or may also be a gNB-CU-User Plane (gNB-CU-UP) configuration update (GNB-CU-UP CONFIGURATION UPDATE) message or a BEARER CONTEXT MODIFICATION RESPONSE message of E1. The ninth message may also be a newly defined message of X2 or Xn or F1 or E1, for example.

The ninth message, for example, may include one or more of the following fields:

(1) a first node identity, which is used to identify the first node.

The identity may be one or more of the following: eNB Measurement ID, NG-RAN node Measurement ID, gNB-CU Measurement ID, gNB-CU-CP Measurement ID.

(2) a second node identity, which is used to identify the second node.

The identity may be one or more of the following: eNB Measurement ID, cn-gNB Measurement ID, NG-RAN node Measurement ID, gNB-DU Measurement ID, gNBCU-UP Measurement ID.

(3) requested content confirmation, which is related information used to confirm at least one of whether the content of the requested achievable quality of service prediction is predicted or not, whether the achievable quality of service can be reported, whether the content of quality of service prediction is predicted, whether the quality of service can be reported, whether the content of achievable quality of experience prediction is predicted, whether the achievable quality of experience can be reported, whether the content of quality of experience prediction is predicted and whether the quality of experience can be reported;

The requested content confirmation can be a single bit representation. For example, a bit of 1 indicates that all the requested content can be predicted, and a bit of 0 indicates that the requested content cannot be predicted.

The requested content confirmation can be a single bit representation, for example. For example, a bit of 1 indicates that all the requested content can be reported, and a bit of 0 indicates that the requested content cannot be reported.

For example, the requested content confirmation can also confirm the prediction request content one by one in the form of bitmap. For example, cach bit corresponds to a prediction content. For example, if the bit is 1, it means that the prediction achievable QoS information of the corresponding prediction content can be transmitted, while 0 means that the prediction achievable QoS information of the corresponding prediction content cannot be transmitted. For example, when the bit is 1, it means that the corresponding content can be transmitted, and 0 means that the corresponding content cannot be transmitted.

For example, the requested content confirmation can also confirm the request content one by one in the form of bitmap. For example, each bit corresponds to a content. For example, if the bit is 1, it means that the information of the corresponding content can be transmitted, while 0 means that the information of the corresponding content cannot be transmitted. For example, when the bit is 1, it means that the corresponding content can be transmitted, and 0 means that the corresponding content cannot be transmitted (4) related information used to indicate reasons for an achievable quality of service request failure. The requested content confirmation may also be that a separate field indicates different content confirmation.

The reasons include at least one of the following: achievable quality of service prediction failure, no prediction ability, no achievable QoS prediction ability, no sufficient data, no achievable quality of service information, quality of service prediction failure, no quality of experience prediction ability, no quality of service information, achievable QoE prediction failure, no achievable QoE information, QoE prediction failure, no QoE information.

(5) a UE identity, which is used to identify the object UE to which the information belongs.

(6) The counting and/or prediction granularity of parameters that cannot be reported, which is used to indicate the granularity of the counting and/or prediction of parameters that cannot be reported. For example, it may include one or more of the followings: UE, QoS flow, QoS level, Data Radio Bearer, slice, cell, node, service, area, operator, etc.

(7) The identity and/or identity list of range for counting and/or prediction of parameters that cannot be reported, which is used to indicate the identity and/or identity list of the range for counting and/or prediction of parameters that cannot be reported, for example, it may include identities of one or more of the followings: UE, QoS flow, QoS level, Data Radio Bearer, slice, cell, node, service, area, operator, etc. The identity of the slice can be single network slice selection assistance information (S-NSSAI). The identity of the cell may be a Physical-layer Cell identity. The identity of the operator may be a Public Land Mobile Network ID (PLMN ID). The identity of QoS level may be a mapped 5G QoS Identifier (5QI) or a QoS Class Identifier (QCI). By being able to feedback the ninth message to the first node when the second node cannot perform the achievable quality of service prediction and/or achievable quality of service reporting and/or quality of service prediction and/or quality of service reporting and/or achievable quality of experience prediction and/or achievable quality of experience reporting and/or quality of experience prediction and/or quality of experience reporting, so that the first node can know that the second node can't perform the achievable quality of service prediction and/or achievable quality of service reporting and/or quality of service prediction and/or quality of service reporting and/or achievable quality of experience prediction and/or achievable quality of experience reporting and/or quality of experience prediction and/or quality of experience reporting according to the request of the first node, thereby avoiding the first node from waiting for a long time.

The achievable quality of service parameters in the eighth message, the ninth message and the tenth message can include at least one of the followings: the achievable highest packet loss rate, the achievable lowest packet loss rate, the achievable maximum time delay, the achievable lowest time delay, the achievable highest throughput, the achievable lowest throughput, the achievable highest data rate, the achievable lowest data rate, the achievable fifth generation quality of service type, the achievable highest quality of service identifier (5QI) type, the achievable lowest quality of service identifier (5QI) type, and the prediction accuracy.

The quality of service parameters in the eighth message, the ninth message and the tenth message may include at least one of the followings: packet loss rate, time delay, throughput, data rate and prediction accuracy, for example.

The RAN visible QoE parameters in the eighth message, the ninth message and the tenth message, for example, can include at least one of the followings: Round-trip time, Jitter duration, Corruption duration, Average throughput, Initial playout delay, Device information, Rendered viewports, Codec information, Buffer level, representation switch events, Play List, media presentation description information (MPD), Interactivity Summary, Interactivity Event List, etc.

The achievable RAN visible QoE parameters in the eighth message, the ninth message and the tenth message can include at least one of the followings: the achievable longest and/or shortest Round-trip time, the achievable longest and/or shortest Jitter duration, the achievable longest and/or shortest Corruption duration, the achievable maximum and/or the minimum average throughput, the achievable longest and/or shortest initial playout delay, the achievable maximum and/or minimum range of device information, the achievable maximum and/or minimum rendered viewports, the achievable maximum and/or minimum range of codec information, the achievable maximum and/or minimum buffer level, the achievable maximum and/or minimum range of representation switch events, the achievable maximum and/or minimum range of play List, the achievable maximum and/or minimum range of media presentation description information (MPD), the achievable maximum and/or minimum range of interactivity summary, the achievable maximum and/or minimum range of interactivity event list, etc.

The QoE parameters in the eighth message, the ninth message and the tenth message may include at least one of the followings: Round-trip time, Jitter duration, Corruption duration, Average throughput, Initial playout delay, Device information, Rendered viewports, Codec information, Buffer level, presentation switch events, Play List, Media presentation description information (MPD information), Interactivity Summary, Interactivity Event List, etc.

The achievable QoE parameters in the eighth message, the ninth message and the tenth message can include at least one of the followings: the achievable longest and/or shortest Round-trip time, the achievable longest and/or shortest Jitter duration, the achievable longest and/or shortest Corruption duration, the achievable maximum and/or the minimum average throughput, the achievable longest and/or shortest initial playout delay, the achievable maximum and/or minimum range of device information, the achievable maximum and/or minimum rendered viewports, the achievable maximum and/or minimum range of codec information, the achievable maximum and/or minimum buffer level, the achievable maximum and/or minimum range of representation switch events, the achievable maximum and/or minimum range of play list, the achievable maximum and/or minimum range of media presentation description information (MPD), the achievable maximum and/or minimum range of interactivity summary, the achievable maximum and/or minimum range of interactivity event list, etc.

The QoE evaluation values in the eighth message, the ninth message and the tenth message, for example, may include at least one of the followings: QoE evaluation value, QoE MOS value, etc.

The achievable QoE evaluation values in the eighth message, the ninth message and the tenth message may include at least one of the followings: the achievable maximum and/or minimum QoE evaluation values, the achievable maximum and/or minimum QOE MOS values, etc.

The achievable QoS evaluation values in the eighth message, the ninth message and the tenth message may include, for example, the achievable maximum and/or minimum QoS evaluation values.

The embodiment of the present disclosure also provides a method for supporting data collection and processing by wireless communication network, which includes:

The first node transmits the eleventh message to the second node to transmit the positioning parameter and other information required for positioning measurement to the second node.

The eleventh message may be, for example but not limited to, a POSITIONING MEASUREMENT REQUEST message or a MEASUREMENT REQUEST message or a POSITIONING INFORMATION REQUEST message of NG or F1. The eleventh message can also be a newly defined message of NG or X2 or Xn or F1, for example.

The eleventh message, for example, may include one or more of the following:

(1) related information of the positioning parameter requested to measure. The parameter may include one or more of the following: reference signal receiving quality (RSRQ), and/or received signal strength indicator (RSSI), uplink sounding reference signal-reference signal receiving quality (SRS-RSRQ), and/or uplink sounding reference signal-received signal strength indicator (SRS-RSSI), and/or a channel state information (CSI) parameter, and/or other channel related information.

The CSI parameter includes one or more of the following: channel impulse response, channel quality indicator (CQI), precoding matrix indicator (PMI), rank indicator (RI), channel state information reference signal resource indicator (CSI-RS Resource Indicator (CRI)), layer indicator (LI), and layer 1 reference signal receiving power (L1-L1-RSRP).

After receiving the eleventh message, the second node performs the measurement of the positioning parameter according to the eleventh message, and transmits a twelfth message to the first node, so that the first node can acquire the related information such as the result of the measured positioning parameter, etc.

The twelfth message may be, for example, but not limited to, a POSITIONING MEASUREMENT RESPONSE message or a MEASUREMENT RESPONSE message or a POSITIONING INFORMATION RESPONSE message or a POSITIONING INFORMATION UPDATE message or an INFORMATION UPDATE message or a POSITIONING MEASUREMENT REPORT message or a MEASUREMENT REPORT message of NG or F1. The twelfth message may also be a newly defined message of NG or X2 or Xn or F1, for example.

The twelfth message, for example, may include one or more of the following fields:
(1) related information of the measured positioning parameters, for example, may include one or more of the following: reference signal receiving quality (RSRQ), and/or received signal strength indicator (RSSI), uplink sounding reference signal-reference signal receiving quality (SRS-RSRQ), and/or uplink sounding reference signal-received signal strength indicator (SRS-RSSI), and/or a channel state information (CSI) parameter, and/or measurement results of other channel related information.

The CSI parameter includes one or more of the following: channel impulse response, channel quality indicator (CQI), precoding matrix indicator (PMI), rank indicator (RI), channel state information reference signal resource indicator (CSI-RS Resource Indicator (CRI)), layer indicator (LI), and layer 1 reference signal receiving power (L1-L1-RSRP).

In this way, reference information is provided for the first node or other nodes to make positioning results, etc., so as to improve positioning accuracy, reduce positioning time delay, reduce signalling overhead required for positioning, and reduce positioning errors caused by the node synchronization.

The embodiment of the present disclosure also provides a method for supporting data collection and processing by wireless communication network, which includes:

The first node transmits a thirteenth message including information for requesting to do the positioning for the user equipment to the second node.

The thirteenth message may be, for example, but not limited to, a POSITIONING MEASUREMENT REQUEST message or a MEASUREMENT REQUEST message or a POSITIONING INFORMATION REQUEST message of X2 or Xn or F1 or NG.

The thirteenth message may also be a newly defined message of X2 or Xn or F1 or NG, for example.

The thirteenth message, for example, may include one or more of the following:

(1) a requested positioning transaction identity, which is related information used to identify requested positioning;

(2) a node ID, which is used to identify the node participating in this measurement.

The identity can be LMF Measurement ID, RAN Measurement ID, etc.

(3) UE identity, which is used to represent the related messages of the UE.

(4) a requested positioning acquisition mode, which is related information used to indicate requested method used in the positioning.

The method includes a method of obtaining positioning by way of measurement or a prediction method of obtaining positioning by way of machine learning.

(5) related information of positioning parameter requested to measure, wherein the parameter includes at least one of the following: reference signal reception quality RSRQ, received signal strength indication RSSI, uplink sounding reference signal-reference signal reception quality SRS-RSRQ, uplink sounding reference signal-received signal strength indication SRS-RSSI, a channel state information CSI parameter.

After receiving the thirteenth message, the second node performs the positioning related operation and transmits a fourteenth message including the information related to the positioning of the user equipment to the first node.

The fourteenth message may be, for example but not limited to, a POSITIONING MEASUREMENT RESPONSE message or a POSITIONING MEASUREMENT FAILURE message or a MEASUREMENT RESPONSE message or a MEASUREMENT FAILURE message or a POSITIONING INFORMATION RESPONSE message or a POSITIONING INFORMATION UPDATE message or an INFORMATION UPDATE message or a POSITIONING MEASUREMENT REPORT message or a MEASUREMENT REPORT message of NG or F1. The fourteenth message may also be a newly defined message of X2 or Xn or F1 or E1, for example.

The fourteenth message, for example, may include one or more of the following fields:

(1) a positioning transaction identity, which is related information used to identify actually performed positioning.

(2) a node identity, which is related information used to identify nodes participating in the positioning.

The identity may be, for example, LMF Measurement ID, RAN Measurement ID, etc.

(3) a UE identity, which is used to represent related information of the UE.

(4) related information of location information.

The related information of location information may be, for example, geographic coordinates, the camping cell, etc.

(5) an acquisition mode, which is related information used to indicate a method used in the performed positioning.

The method may include, for example, a method of obtaining positioning by measurement or a prediction method of obtaining positioning by machine learning.

(6) a calculation method, which is related information used to indicate a calculation method used in the performed positioning.

The method may include, but is not limited to, Cell-ID (CID), Enhanced Cell ID (E-CID), observed time difference of arrival (OTDOA), etc.

(7) related information of prediction accuracy, which is used to represent related information of the prediction accuracy of the positioning result obtained by using machine learning model and other technologies to predict.

(8) related information used to indicate reasons for a positioning failure, for example, the reasons include a positioning failure, no positioning function, no sufficient data, etc.

(9) related information of measured positioning parameters. The parameters include at least one of the following: reference signal reception quality RSRQ, received signal strength indication RSSI, uplink sounding reference signal-reference signal reception quality SRS-RSRQ, uplink sounding reference signal-received signal strength indication SRS-RSSI, a channel state information CSI parameter;

In this way, the first node can acquire the location information of the UE, so as to improve the positioning accuracy, reduce the positioning delay, reduce the signalling overhead required for positioning, reduce the positioning error caused by the node synchronization, and provide reference information for the first node to make decision of resource allocation and handover, so as to improve the effectiveness of resource allocation and the success rate of the handover.

Embodiments of the present disclosure are further described below with reference to the accompanying drawings.

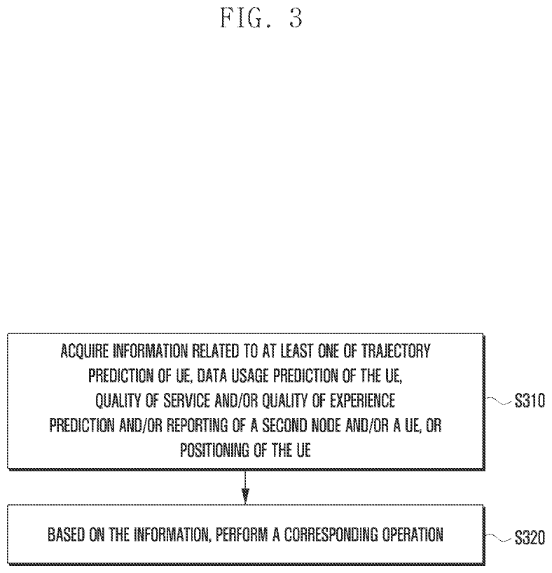

Please refer to FIG. 3, which illustrates a flow chart of a method performed by a first node provided by an embodiment of the present disclosure, which includes step S310 and step S320.

Step S310, acquire information related to at least one of trajectory prediction of user equipment, data usage prediction of the user equipment, quality of service and/or quality of experience prediction and/or reporting of a second node and/or a UE, or positioning of the user equipment;

Step S320, based on the information, perform a corresponding operation.

Through the above method, the first node can acquire information related to at least one of trajectory prediction of user equipment, data usage prediction of the user equipment, quality of service and/or quality of experience prediction and/or reporting of the second node and/or the UE, or positioning of the user equipment, and perform a corresponding operation based on the above information, so as to provide reference information for the first node to make a decision for the UE on whether or not to perform a handover on the UE, the handover time, the selection of target nodes, etc., thereby reducing handover failures, handover ping-pong, too many candidate target nodes, etc., thereby improving the success rate of handover. In addition, it helps the first node to do resource allocation for the UE, which can improve the effectiveness of resource allocation. Furthermore, it also provides reference information for the first node to make decision of energy saving, load balancing, etc., so as to ensure the QoS performance after UE handover, the performance after load migration, the performance after the implementation of energy-saving strategy and avoid ping-pong of energy-saving switch; besides, it also provides reference information for the first node or other nodes to make positioning results, so as to improve positioning accuracy, reduce positioning delay, reduce signalling overhead required for positioning, and reduce positioning errors caused by the node synchronization.

This disclosure will be described with more specific examples below, but it can be understood that this disclosure is not limited to the following examples. Without departing from the technical concept of this disclosure, any scene change, name change of the first node and the second node, name change of messages exchanged between the first node and the second node, etc. all belong to the scope of protection of this disclosure.

Embodiment 1 describes an aspect of supporting collection and processing of wireless communication network data according to the embodiment of the present disclosure.

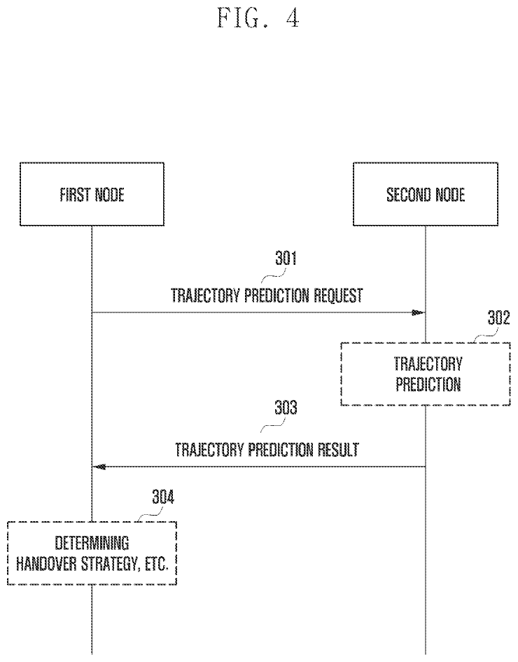

FIG. 4 illustrates yet another schematic diagram of a process of interaction of information associated with trajectory prediction of user equipment between a first node and a second node according to an embodiment of the present disclosure.

Step 301: the first node transmits a trajectory prediction request to the second node to request the second node to predict the trajectory of the UE.

In an implementation, for example, the message may be the aforementioned first message.

In an implementation, for example, the first node can be gNB or gNB CU-CP or en-gNB or eNB or ng-eNB, and the second node can be gNB or gNB CU-CP or en-gNB or eNB or ng-eNB.

Step 302, the second node performs trajectory prediction based on the collected location information of the UE.

In an implementation, for example, the trajectory prediction can be realized by a machine learning model.

Step 303, the second node transmits the trajectory prediction result to the first node to inform the first node about the trajectory prediction result of the UE.

In an implementation, for example, the trajectory prediction result may be the aforementioned second message.

If the second node is unable to report the trajectory prediction result of the UE according to the trajectory prediction request, it will notify the first node of the trajectory prediction request failure and will not proceed to step 304.

In an implementation, for example, the trajectory prediction request failure may be the aforementioned third message.

Step 304, the first node can determine whether to hand over the UE, the time of handover, the target node of handover, etc. according to the trajectory prediction result and/or measurement report.

In an implementation, for example, a node for which a measurement report is greater than a predetermined threshold value and trajectory camping time is greater than a predetermined threshold value is identified as a target node of handover.

In this way, the trajectory information of the UE in the requested time interval is provided for the first node, and reference information is provided for the first node to determine whether the UE is to be handed over or not, as well as the handover time and target nodes, etc., which reduces the situations of handover failures, handover ping-pong, too many candidate target nodes and the like, thereby improving the success rate of handover.

Embodiment 2 describes a schematic diagram of an aspect of supporting collection and processing of wireless communication network data according to an embodiment of the present disclosure.

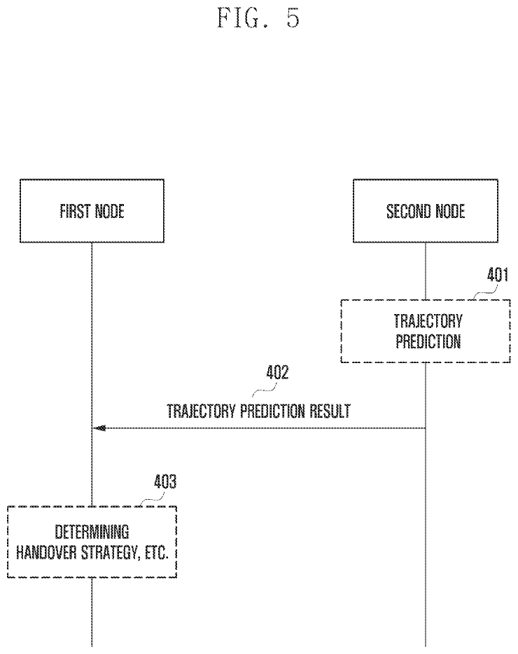

FIG. 5 illustrates another schematic diagram of a process of interaction of information associated with trajectory prediction of user equipment between a first node and a second node according to an embodiment of the present disclosure.

Step 401, the second node performs trajectory prediction based on the collected location information of the UE.

In an implementation, for example, the trajectory prediction can be realized by a machine learning model.

In an implementation, for example, the second node can be gNB or gNB CU-CP or en-gNB or eNB or ng-eNB.

Step 402, the second node transmits the trajectory prediction result to the first node according to its own situation, so as to inform the first node of the prediction result of the UE.

In an implementation, for example, the trajectory prediction result may be a second message.

In an implementation, for example, the first node can be gNB or gNB CU-CP or en-gNB or eNB or ng-eNB.

Step 403, the first node can determine whether to hand over the UE, the time of handover, the target node of handover, etc. according to the trajectory prediction result and/or measurement report.

In an implementation, for example, a node for which a measurement report is greater than a predetermined threshold value and trajectory camping time is greater than a predetermined threshold value is identified as a target node of handover.

In this way, the first node and the second node interact with each other the information associated with the trajectory prediction of the user equipment according to their own situation, providing the trajectory information of the UE in the requested time interval for the first node, and providing reference information for the first node to make a decision about whether to hand over the UE, the decision of the handover time, the selection of the target node, etc., so as to reduce the cases of handover failures, handover ping pong, too many candidate target nodes, etc., thereby improving the success rate of handover.

Embodiment 3 describes an aspect of supporting collection and processing of wireless communication network data according to the embodiment of the present disclosure.

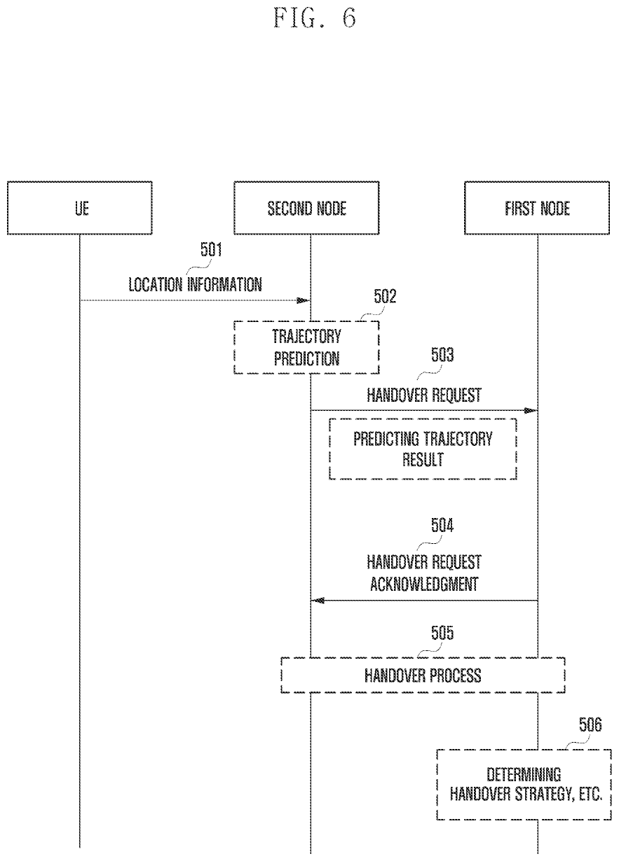

FIG. 6 illustrates yet another schematic diagram of a process of interaction of information associated with trajectory prediction of user equipment between a first node and a second node according to an embodiment of the present disclosure.

Step 501, the UE reports its own location information to the second node.

In an implementation, for example, the report message may be a MEASUREMENT REPORT.

Step 502, the second node performs trajectory prediction based on the collected location information of the UE.

In an implementation, for example, the trajectory prediction can be realized by a machine learning model.

Step 503, the second node transmits the trajectory prediction result to the first node in the handover request for the UE to inform the first node about the trajectory prediction result of the UE.

In an implementation, for example, the trajectory prediction result may be a second message.

In an implementation, for example, the first node can be gNB or gNB CU-CP or en-gNB or eNB or ng-eNB, and the second node can be gNB or gNB CU-CP or en-gNB or eNB or ng-eNB.

Step 504, the first node transmits a handover request acknowledgment message to the second node to confirm the handover request.

Step 505, the second node and the first node perform a handover process for the UE.

Step 506, the first node can determine whether to hand over the UE, the time of handover, the target node of handover, etc. according to the trajectory prediction result and/or measurement report.

In an implementation, for example, a node for which a measurement report is greater than a predetermined threshold value and trajectory camping time is greater than a predetermined threshold value is identified as a target node of handover.

In this way, the trajectory information of the UE in the requested time interval is provided for the first node, and reference information is provided for the first node to make a decision on whether to hand over the UE, the decision of the handover time, the selection of the target node, etc., so as to reduce the cases of handover failures, handover ping-pong, too many candidate target nodes and the like, thereby improving the success rate of handover.

Embodiment 4 describes a schematic diagram of an aspect of supporting collection and processing of wireless communication network data according to an embodiment of the present disclosure.

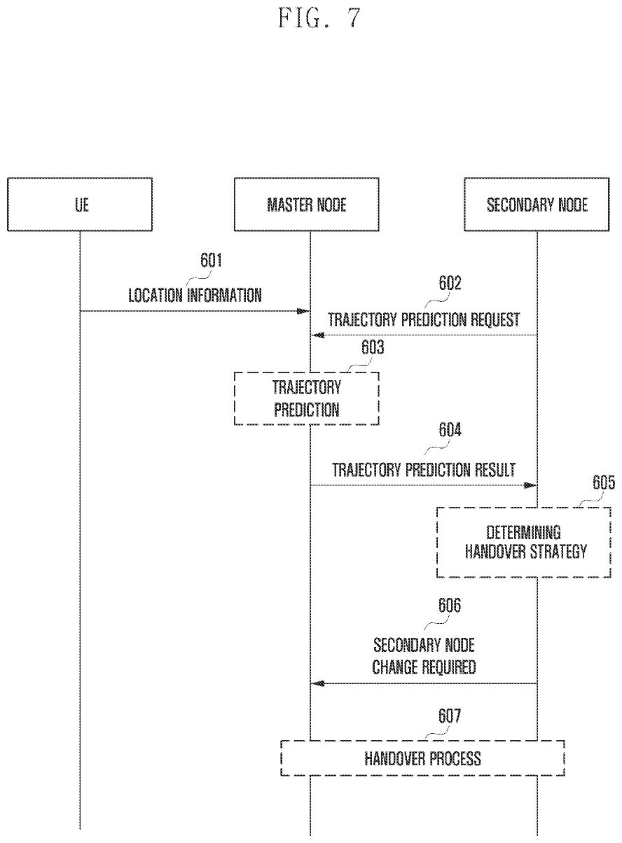

FIG. 7 illustrates a schematic diagram of a process of interaction of information associated with trajectory prediction of user equipment between a master node and a secondary node in the case of dual connectivity according to an embodiment of the present disclosure.

Step 601, the UE reports its own location information to the master node. In an implementation, for example, the report message may be a MEASUREMENT REPORT.

Step 602, the secondary node transmits a trajectory prediction request to the master node, requesting the master node to predict the trajectory of the UE.

In an implementation, for example, the trajectory prediction request may be the aforementioned first message.

In an implementation, the secondary node is the first node and the master node is the second node, and for example, the first node can be gNB or gNB CU-CP or en-gNB or eNB or ng-eNB, and the second node can be gNB or gNB CU-CP or en-gNB or eNB or ng-eNB.

Step 603, the master node performs trajectory prediction based on the collected UE location information.

In an implementation, for example, the trajectory prediction can be realized by a machine learning model.

Step 604, the master node transmits the trajectory prediction result to the secondary node to inform the secondary node about the trajectory prediction result of the UE.

In an implementation, for example, the trajectory prediction result may be the aforementioned second message.

Step 605, the secondary node determines whether to hand over the UE, the handover time and the target node of handover according to the trajectory prediction result and/or measurement report, etc.

In an implementation, for example, a node for which a measurement report is greater than a predetermined threshold value and trajectory camping time is greater than a predetermined threshold value is identified as a target node of handover.

Step 606, according to the decision of step 605, the secondary node transmits a secondary node change required message to the master node for handover of the UE.

Step 607, the secondary node and the master node perform a handover process on the UE.

Due to the situations such as limited data or limited computing power of the secondary nodes, through the above method, the master node can perform trajectory prediction and provide the trajectory information of the UE in the requested time interval to the secondary nodes, and provide reference information for the secondary nodes to make the decision on whether to hand over, the decision on the handover time, the selection of target nodes, etc. in the subsequent time, so as to reduce the handover failure, ping-pong handover, too many candidate target nodes, etc., and thus improve the success rate of the handover.

In addition, the machine learning models for trajectory prediction in embodiments 1, 2, 3 and 4 can be implemented as follows, for example.

The input of the models may include one or more of the following: the identity of the UE, the time point, location coordinates, the camping cell, movement velocity (including speed value and/or direction), etc. The models can be trained by online learning, offline learning, supervised learning, unsupervised learning and reinforcement learning, etc. The models can include, but are not limited to, perceptron, feedforward neural network, radial basis network, deep feedforward network, recurrent neural network, long/short-term memory network, gated recurrent unit, auto encoder, variational auto encoder, denoising auto encoder, sparse auto encoder, Markov chain, Hopfiled network, Boltzmann machine, restricted Boltzmann machine, deep belief network, deep convolutional network, deconvolutional network, deep convolutional inverse graphics network, generative adversarial network, liquid state machine, extrame learning machine, echo state network, deep residual network, Kohonen network, support vector machine, neural turing machine, convolutional neural network, artificial neural network, recurrent neural network, deep neural network, etc. The output of the models can include one or more of the following: the time point, location coordinates, estimated velocity (including speed value and/or direction), cell identity (such as Cell Global ID, etc.), a trajectory special case type, a trajectory special case coordinate point and/or area, etc.

Embodiment 5 describes an aspect of supporting collection and processing of wireless communication network data according to the embodiment of the present disclosure.

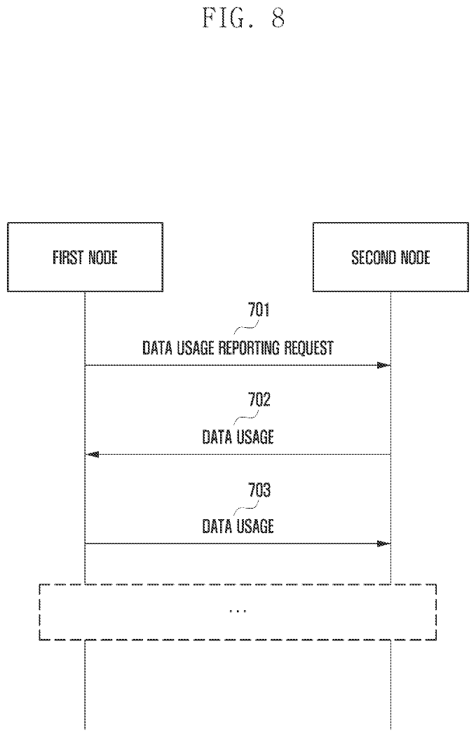

FIG. 8 illustrates a schematic diagram of a process of interaction of information associated with data usage reporting requirement of user equipment between a first node and a second node according to an embodiment of the present disclosure;

Step 701, the first node transmits a data usage reporting request to the second node, so that the second node can report the data usage of the UE to the first node according to the data usage reporting request.

In an implementation, for example, the data usage reporting request may be the aforementioned fourth message.

In an implementation, for example, the first node may be gNB CU-CP and the second node may be gNB CU-UP.

Step 702, the second node reports the data usage of the UE to the first node.

In an implementation, for example, the data usage can be a DATA USAGE REPORT message or an MR-DC DATA USAGE REPORT message.

If the periodic reporting is required in the data usage reporting request in step 701, then step 703 and the reporting afterwards are performed. If the data usage reporting request in step 701 requires the on-demand reporting, step 703 and the reporting afterwards will not be performed.

Step 703, the second node reports the data usage of the UE to the first node.

In an implementation, for example, the data usage can be a DATA USAGE REPORT message or an MR-DC DATA USAGE REPORT message.

In this way, the data usage of the UE counted in the second node is provided to the first node, so that the first node can optimize resource allocation, predict data usage and the like for the UE.

Embodiment 6 describes a schematic diagram of an aspect of supporting collection and processing of wireless communication network data according to an embodiment of the present disclosure.

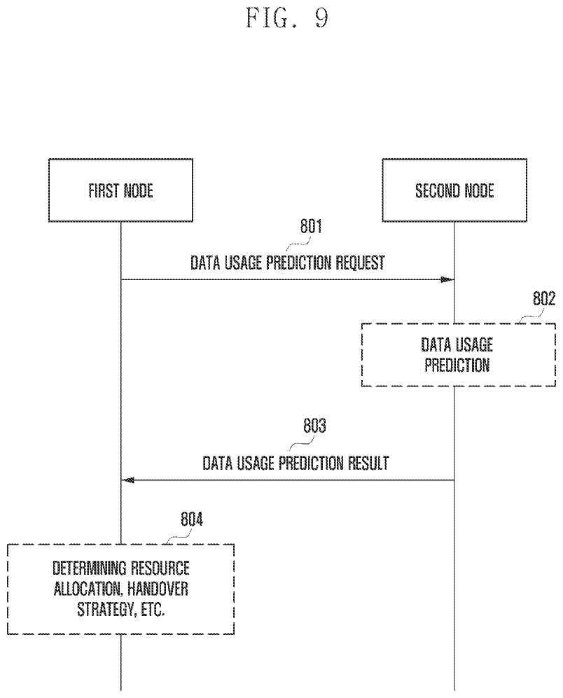

FIG. 9 illustrates a schematic diagram of a process of interaction of information associated with data usage prediction of user equipment between a first node and a second node according to an embodiment of the present disclosure.

Step 801, the first node transmits a data usage prediction request to the second node to request the second node to predict the data usage of the UE.

In an implementation, for example, the data usage prediction request may be the aforementioned fifth message.

In an implementation, for example, the first node can be gNB or gNB CU-CP or en-gNB or eNB or ng-eNB, and the second node can be gNB or gNB CU-CP or en-gNB or eNB or ng-eNB.

In yet another implementation, for example, the first node may be gNB CU-CP and the second node may be gNB CU-UP.

In further another implementation, for example, the first node may be gNB CU-UP and the second node may be gNB CU-CP.

Step 802, the second node predicts the data usage based on the collected UE data usage information.

In an implementation, for example, data usage prediction can be implemented by a machine learning model.

Step 803, the second node transmits the data usage prediction result to the first node to inform the first node of the prediction result of the UE.

In an implementation, for example, the data usage prediction result may be the aforementioned sixth message.

If the second node is unable to report the data usage prediction result of the UE according to the data usage prediction request, it will notify the first node of the data usage prediction request failure and will not proceed to step 804.

In an implementation, for example, the data usage prediction request failure message may be the aforementioned seventh message.

Step 804, the first node can determine the resource allocation strategy and/or the handover target node of the UE according to the data usage prediction result.

In an implementation, for example, the resources reserved for the UE can support the predicted maximum data usage of the UE.

In another implementation, for example, when determining the handover target node, the nodes that cannot support the predicted maximum data usage of the UE are excluded.

In this way, the second node provides the first node with the data usage prediction result of the UE in the requested time interval, provides reference information for determining the resource allocation of the UE and the selection of the handover target node, etc., ensures the QoS performance of the UE, and reduces casessuch as handover failures and the like.

Embodiment 7 describes a schematic diagram of an aspect of supporting collection and processing of wireless communication network data according to an embodiment of the present disclosure.

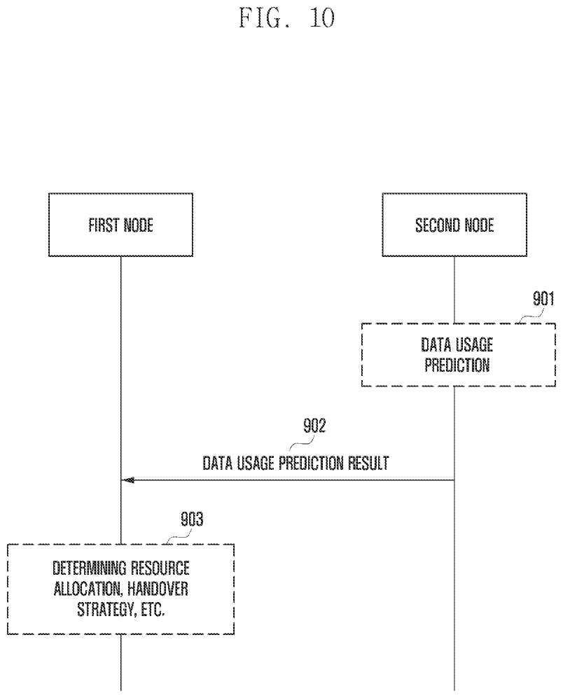

FIG. 10 illustrates another schematic diagram of a process of interaction of information associated with data usage prediction of user equipment between a first node and a second node according to an embodiment of the present disclosure.

Step 901, the second node predicts the data usage based on the collected UE data usage information.

In an implementation, for example, the data usage prediction can be implemented by a machine learning model.

Step 902, the second node transmits the data usage prediction result to the first node according to its own situation, so as to inform the first node of the prediction result of the UE.

In an implementation, for example, the data usage prediction result may be the aforementioned fifth message.

In an implementation, for example, the first node can be gNB or gNB CU-CP or en-gNB or eNB or ng-eNB, and the second node can be gNB or gNB CU-CP or en-gNB or eNB or ng-eNB.

In yet another implementation, for example, the first node may be gNB CU-CP and the second node may be gNB CU-UP.

In further another implementation, for example, the first node may be gNB CU-UP and the second node may be gNB CU-CP.

Step 903, the first node can determine the resource allocation strategy of the UE and/or the handover target node according to the data usage prediction result.

In an implementation, for example, the resources reserved for the UE can support the predicted maximum data usage of the UE.

In another implementation, for example, when determining the handover target node, the nodes that cannot support the predicted maximum data usage of the UE are excluded.

By interacting information related to data usage prediction of user equipment between the first node and the second node according to their own situations, the second node provides the first node with the data usage prediction result of the UE in the requested time interval, provides reference information for determining resource allocation of the UE and selection of handover target node, etc., ensures QoS performance of the UE, and reduces cases such as handover failure and the like.

Embodiment 8 describes a schematic diagram of an aspect of supporting collection and processing of wireless communication network data according to an embodiment of the present disclosure.

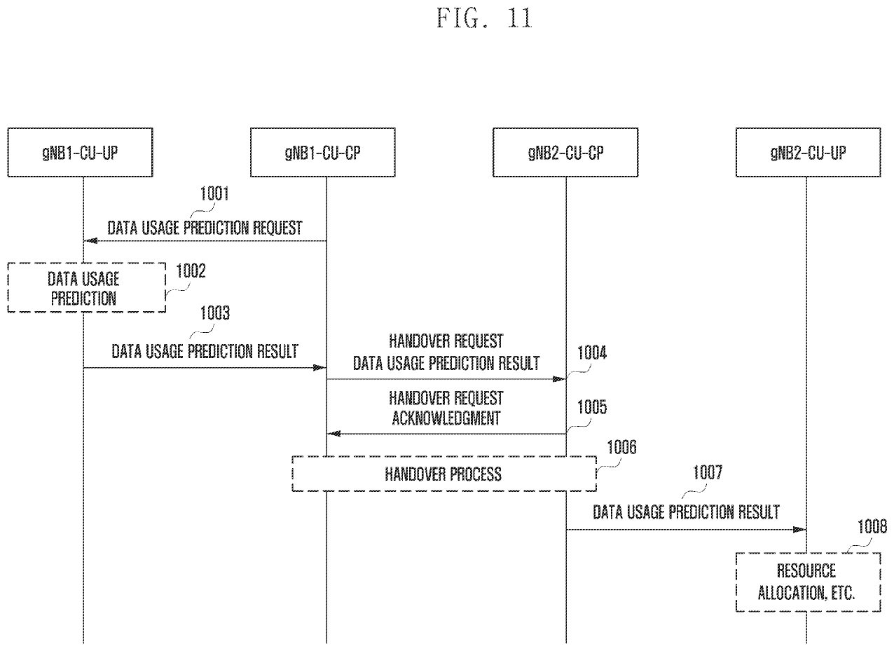

FIG. 11 is a schematic diagram of a process of interaction of information associated with data usage prediction of user equipment between nodes according to their own conditions during handover under the split architecture of gNB CU-UP and gNB CU-CP according to an embodiment of the present disclosure.

Step 1001, gNB1-CU-CP transmits a data usage prediction request to gNB1-CU-UP to request the gNB1-CU-UP to predict the data usage of UE and feedback the data usage prediction result of the UE to the gNB1-CU-CP.

In an implementation, for example, the data usage prediction request may be the aforementioned fifth message.

Step 1002, the gNB1-CU-UP predicts the data usage based on the collected UE data usage information.

In an implementation, for example, the data usage prediction can be implemented by a machine learning model.

Step 1003, the gNB1-CU-UP transmits the data usage prediction result to the gNB1-CU-CP to inform the gNB1-CU-CP of the data usage prediction result of the UE.

In an implementation, for example, the data usage prediction result may be the aforementioned sixth message.

If the gNB1-CU-UP cannot report the data usage prediction result of the UE according to the data usage prediction request, it will notify the first node of the data usage prediction request failure.

In an implementation, for example, the data usage prediction request failure may be the aforementioned seventh message.

It is implemented by the gNB1-CU-CP on whether to proceed with step 1004 and subsequent steps.

Step 1004, the gNB1-CU-CP transmits the data usage prediction result to gNB2-CU-CP in the handover request for the UE, so as to inform the gNB2-CU-CP of the data usage prediction result of the UE.

In an implementation, for example, the data usage prediction result may be the aforementioned sixth message.

Step 1005, the gNB2-CU-CP transmits a handover request acknowledgment message to the gNB1-CU-CP to confirm the handover request.

Step 1006, the gNB1-CU-CP and the gNB2-CU-CP perform handover process on the UE.

Step 1007, the gNB2-CU-CP transmits the data usage prediction result to the gNB2-CU-UP to inform the gNB2-CU-UP of the data usage prediction result of the UE.

In an implementation, for example, the data usage prediction result may be the aforementioned sixth message.

Step 1008, the gNB2-CU-UP can determine the resource allocation strategy of the UE according to the data usage prediction result.

In an implementation, for example, the resources reserved for the UE can support the predicted maximum data usage of the UE.

In this way, the data usage prediction result of the UE in the requested time period is provided for the target node, and reference information is provided for the target node to determine the resource allocation of the UE and the selection of the handover target node, etc., in the subsequent time period, so that the QoS performance of the UE is guaranteed, and the cases such as handover failures and the like are reduced.

Embodiment 9 describes a schematic diagram of an aspect of supporting collection and processing of wireless communication network data according to an embodiment of the present disclosure.

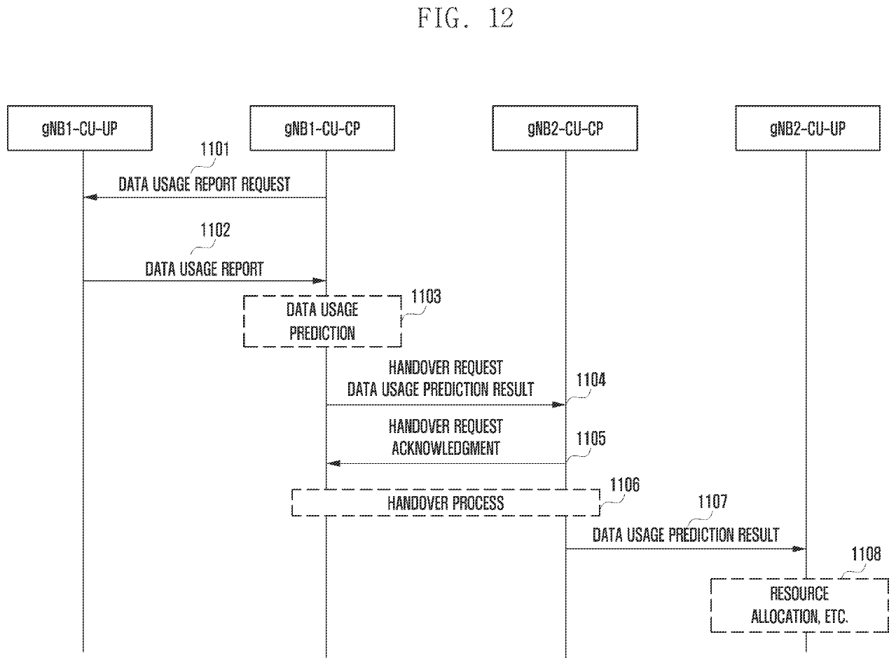

FIG. 12 is a schematic diagram of a process of interaction of information associated with data usage information of user equipment between nodes according to their own conditions during handover under the split architecture of gNB CU-UP and gNB CU-CP according to an embodiment of the present disclosure.

Step 1101, gNB1-CU-CP transmits a data usage reporting request to gNB1-CU-UP, so that the gNB1-CU-UP reports the data usage of the UE to the gNB1-CU-CP according to the data usage reporting request.

In an implementation, for example, the data usage reporting request may be the aforementioned fourth message.

Step 1102, the gNB1-CU-UP reports the data usage of the UE according to the data usage reporting request.

In an implementation, for example, the message may be a DATA USAGE REPORT message or an MR-DC DATA USAGE REPORT message.

If the periodic reporting is required in the data usage reporting request of step 1101, step 1102 is performed periodically according to the data usage reporting request.

If the on demand reporting is required in the data usage reporting request in step 1101, step 1102 is only performed once, that is, the reporting is performed for one time.

Step 1103, the gNB1-CU-CP predicts the data usage based on the collected UE data usage information.

In an implementation, for example, the data usage prediction can be implemented by a machine learning model.

Step 1104, the gNB1-CU-CP transmits the data usage prediction result to gNB2-CU-CP in the handover request for the UE, so as to inform the gNB2-CU-CP of the data usage prediction result of the UE.

In an implementation, for example, the data usage prediction result may be the aforementioned sixth message.

Step 1105, the gNB2-CU-CP transmits a handover request acknowledgment message to the gNB1-CU-CP to confirm the handover request.

Step 1106, the gNB1-CU-CP and the gNB2-CU-CP perform handover process on the UE.

Step 1107, the gNB2-CU-CP transmits the data usage prediction result to the gNB2-CU-UP to inform the gNB2-CU-UP of the data usage prediction result of the UE.

In an implementation, for example, the data usage prediction result may be the aforementioned sixth message.

Step 1108, the gNB2-CU-UP can determine the resource allocation strategy of the UE according to the data usage prediction result.

In an implementation, for example, the resources reserved for the UE can support the predicted maximum data usage of the UE.

In this way, the data usage prediction result of the UE in the requested time period is provided for the target node, and reference information is provided for the target node to determine the resource allocation of the UE and the selection of the handover target node, etc., in the subsequent time period, so that the QoS performance of the UE is guaranteed, and the cases such as handover failures and the like are reduced.

Embodiment 10 describes an aspect of supporting collection and processing of wireless communication network data according to the embodiment of the present disclosure.

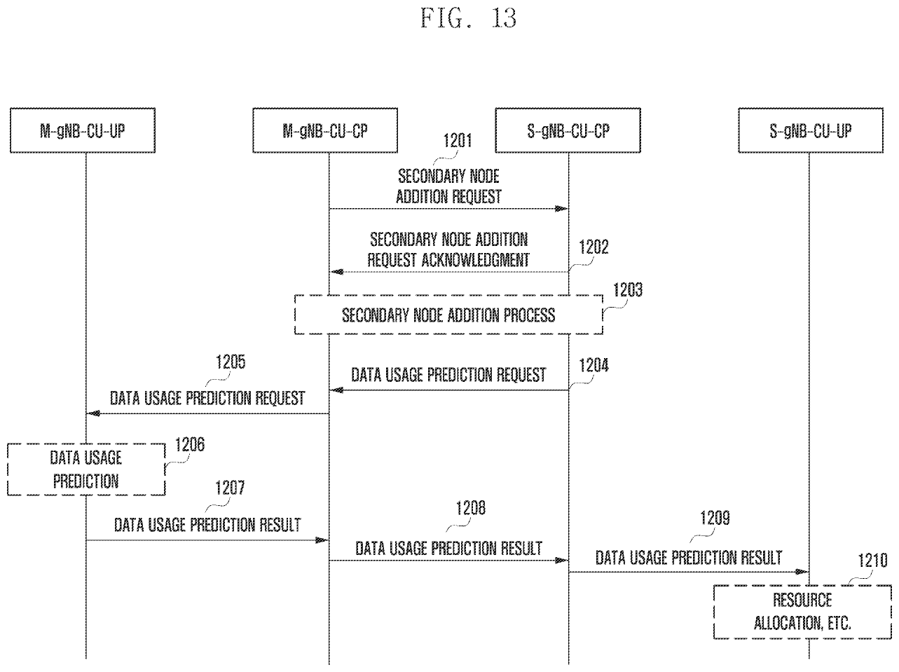

FIG. 13 illustrates a schematic diagram of a process of interaction of information associated with data usage information of user equipment between a master node and a secondary node according to their own conditions in the case of dual connectivity according to an embodiment of the present disclosure.

Step 1201, M-gNB-CU-CP transmits a secondary node addition request to SgNB-CU-CP to request the addition of S-gNB as a secondary node.

Step 1202, S-gNB-CU-CP transmits a secondary node addition request acknowledgment message to the M-gNB-CU-CP to confirm the secondary node addition request.

Step 1203, the M-gNB-CU-CP and the S-gNB-CU-CP perform the secondary node addition process.

Step 1204, the S-gNB-CU-CP transmits a data usage prediction request to the MgNB-CU-CP to inform the M-gNB-CU-CP that it needs to feedback the data usage prediction result of the UE to the S-gNB-CU-CP.

In an implementation, for example, the data usage prediction request may be the aforementioned fifth message.

Step 1205, the M-gNB-CU-CP transmits a data usage prediction request to MgNB-CU-UP to inform the M-gNB-CU-UP that it needs to feedback the data usage prediction result of the UE to the M-gNB-CU-CP.

In an implementation, for example, the data usage prediction request may be the aforementioned fifth message.

Step 1206, the M-gNB-CU-UP predicts the data usage based on the collected UE data usage information.

In an implementation, for example, data usage prediction can be implemented by a machine learning model.

Step 1207, the M-gNB-CU-UP transmits the data usage prediction result to the MgNB-CU-CP to inform the M-gNB-CU-CP of the data usage prediction result of the UE.

In an implementation, for example, the data usage prediction result may be the aforementioned sixth message.

If the M-gNB-CU-UP cannot report the data usage prediction result of the UE according to the data usage prediction request in step 1205, it will notify the MgNB-CU-CP of the data usage prediction request failure.

In an implementation, for example, the data usage prediction request failure may be the aforementioned seventh message.

Step 1208, the M-gNB-CU-CP transmits the data usage prediction result of the UE to the S-gNB-CU-CP to inform the S-gNB-CU-CP of the data usage prediction result of the UE.

In an implementation, for example, the data usage prediction result may be the aforementioned sixth message.

If the M-gNB-CU-CP cannot report the data usage prediction result of the UE according to the data usage prediction request in step 1204, it will notify the SgNB-CU-CP of the data usage prediction request failure.

In an implementation, for example, the data usage prediction request failure may be the aforementioned seventh message.

It is decided by the S-gNB-CU-CP on whether to proceed with step 1209 and subsequent steps.

Step 1209, the S-gNB-CU-CP transmits the data usage prediction result to the SgNB-CU-UP to inform the S-gNB-CU-UP of the data usage prediction result of the UE.

In an implementation, for example, the data usage prediction result may be the aforementioned sixth message.

Step 1210, the S-gNB-CU-UP can determine the resource allocation strategy of the UE according to the data usage prediction result.

In an implementation, for example, the resources reserved for the UE can support the predicted maximum data usage of the UE.

Due to the situations such as limited data or limited computing power of the secondary node, through the above method, the master node can predict the data usage and provide the secondary node with the data usage prediction result of the UE in the requested time period, providing reference information for the secondary node to determine the resource allocation of the UE and the selection of the handover target node, etc., in the subsequent time period, ensuring the QoS performance of the UE, and reducing the situations such as handover failure and the like.

The machine learning model for data usage prediction in Embodiments 6, 7, 8, 9 and 10 can be implemented in the following ways, for example.

The input of the models may include one or more of the following: the identity of the UE, the time point, uplink and/or downlink data usage, etc. The models can be trained by online learning, offline learning, supervised learning, unsupervised learning and reinforcement learning, etc. The model can include, but is not limited to, perceptron, feedforward neural network, radial basis network, deep feedforward network, recurrent neural network, long/short-term memory network, gated recurrent unit, auto encoder, and variational auto encoder, denoising auto encoder, sparse auto encoder, Markov chain, Hopfiled network, Boltzmann machine, restricted Boltzmann machine, deep belief network, deep convolutional network, deconvolutional network, deep convolutional inverse graphics network, generative adversarial network, liquid state machine, extrame learning machine, echo state network, deep residual network, Kohonen network, support vector machine, neural turing machine, convolutional neural network, artificial neural network, recurrent neural network, deep neural network, etc. The output of the models can include one or more of the following: the time point, uplink data usage prediction, downlink data usage prediction, a data usage special case type, data usage special case time and/or time interval, etc.

Embodiment 11 describes an aspect of supporting collection and processing of wireless communication network data according to the embodiment of the present disclosure.

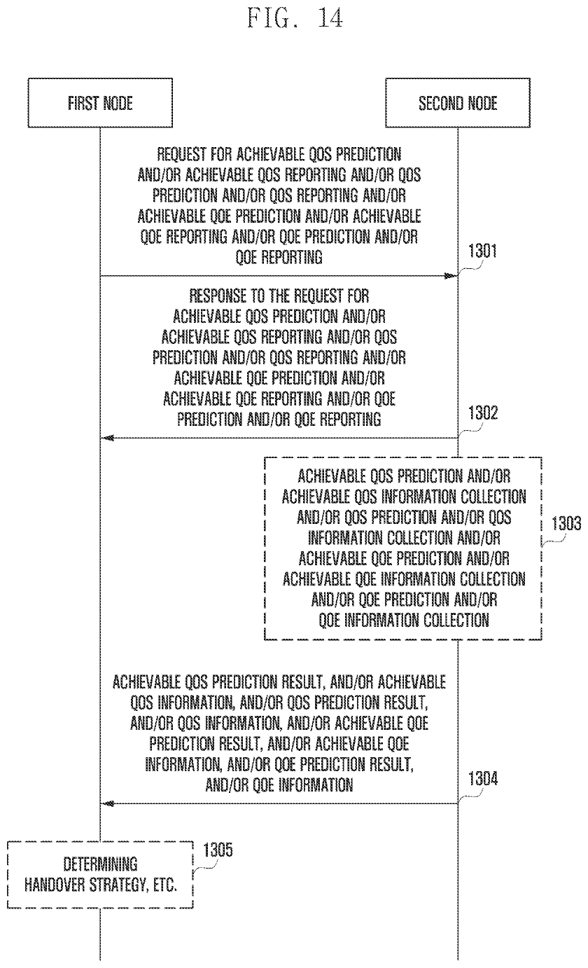

FIG. 14 illustrates a schematic diagram of a process of interaction of information associated with achievable QoS prediction, and/or achievable QoS, and/or QoS prediction, and/or QoS, and/or achievable QoE prediction, and/or achievable QoE, and/or QoE prediction, and/or QoE of a second node and/or a UE between a first node and the second node according to an embodiment of the present disclosure.

Step 1301, the first node transmits a request for achievable QoS prediction, and/or achievable QoS reporting, and/or QoS prediction, and/or QoS reporting, and/or achievable QoE prediction, and/or achievable QoE reporting, and/or QoE prediction, and/or QoE reporting to the second node to inform the second node to feedback the achievable QoS prediction information, and/or achievable QoS information, and/or QoS prediction information, and/or QoS information, and/or achievable QoE prediction information, and/or achievable QoE information, and/or QoE prediction information, and/or QoE information of the second node and/or the UE to the first node.

In an implementation, for example, the request for the achievable QoS prediction, and/or achievable QoS reporting, and/or QoS prediction, and/or QoS reporting, and/or achievable QoE prediction, and/or achievable QoE reporting, and/or QoE prediction, and/or QoE reporting may be the aforementioned eighth message.

In an implementation, for example, the first node can be gNB or gNB CU-CP or en-gNB or eNB or ng-eNB, and the second node can be gNB or gNB CU-CP or en-gNB or eNB or ng-eNB.

In yet another implementation, for example, the first node may be gNB CU-CP and the second node may be gNB CU-UP.

In yet another implementation, for example, the first node may be gNB CU and the second node may be gNB DU.

Step 1302, the second node transmits a response to the request for achievable QoS prediction, and/or achievable QoS reporting, and/or QoS prediction, and/or QoS reporting, and/or achievable QoE prediction, and/or achievable QoE reporting, and/or QoE prediction, and/or QoE reporting to the first node, so as to inform the first node whether the second node can perform the achievable QoS prediction, and/or achievable QoS reporting, and/or QoS prediction, and/or QoS reporting, and/or achievable QoE prediction, and/or achievable QoE reporting, and/or QoE prediction, and/or QoE reporting.

In an implementation, for example, the response to the request for the achievable QoS prediction, and/or achievable QoS reporting, and/or QoS prediction, and/or QoS reporting, and/or achievable QoE prediction, and/or achievable QoE reporting, and/or QoE prediction, and/or QoE reporting may be the aforementioned ninth or tenth message.

If the second node can't perform the achievable QoS prediction, and/or achievable QoS reporting, and/or QoS prediction, and/or QoS reporting, and/or achievable QoE prediction, and/or achievable QoE reporting, and/or QoE prediction, and/or QoE reporting in step 1302, step 1303 and subsequent steps are not performed.

Step 1303, the second node performs the achievable QoS prediction, and/or QoS prediction, and/or achievable QoE prediction, and/or QoE prediction based on the collected resource information and/or achievable QoS information and/or QoS information, and/or achievable QoE information, and/or QoE information; or the second node collects the information of achievable QoS and/or QoS, and/or achievable QoE, and/or QoE.

In an implementation, for example, achievable QoS prediction, and/or QoS prediction, and/or achievable QoE prediction, and/or QoE prediction can be implemented by a machine learning model.

Step 1304, the second node transmits the achievable QoS prediction result, and/or achievable QoS information, and/or QoS prediction result, and/or QoS information, and/or achievable QoE prediction result, and/or achievable QoE information, and/or QoE prediction result, and/or QoE information to the first node to inform the first node of the achievable QoS prediction result and/or achievable QoS information, and/or QoS prediction result, and/or QoS information, and/or achievable QoE prediction result, and/or achievable QoE information, and/or QoE prediction result, and/or QoE information of the second node and/or the UE.

In an implementation, for example, the achievable QoS prediction result, and/or achievable QoS information, and/or QoS prediction result, and/or QoS information, and/or achievable QoE prediction result, and/or achievable QoE information, and/or QoE prediction result, and/or QoE information may be the aforementioned tenth message.

If periodic reporting of the prediction result is required in the prediction request in step 1301, step 1303 and step 1304 are performed periodically.

Step 1305, the first node can determine a handover strategy for the UE according to the achievable QoS prediction result and/or achievable QoS information, and/or QoS prediction result, and/or QoS information, and/or achievable QoE prediction result, and/or achievable QoE information, and/or QoE prediction result, and/or QoE information of the second node and/or the UE, such as selecting the handover target node, deciding the load balancing decision, deciding the energy saving decision, etc.

In an implementation, for example, when determining the handover target node, the nodes of which the predicted achievable QoS prediction result and/or QoS prediction result cannot support the QoS requirement of the UE are excluded.

In another implementation, for example, when making load balancing decisions, the user loads with different QoS requirements are migrated to the neighbour nodes that can meet their QoS requirements.

In yet another implementation, for example, when the handover target node confirms, the nodes whose the predicted achievable QoE prediction result and/or the QoE prediction result cannot support the QoE requirement of the UE are excluded.

In yet another implementation, for example, when making load balancing decisions, user loads with different QoE requirements are migrated to corresponding neighboring nodes that can meet the respective QoE requirements.

In another implementation, for example, when making energy-saving decisions, if the self-load is small, but the achievable QoS and/or achievable QoE of neighbour nodes is reduced, energy-saving operation (such as station switch-off) will not be performed, so as to prevent the station start-up operation after a short time and the energy loss due to the on/off of the station.

In this way, the second node provides the first node with the predicted and/or actual achievable QoS information and/or QoS information and/or achievable QoE information and/or QoE information of the second node and/or the UE within the requested time period, and provides reference information for the first node to select the handover target node, make load balance decisions, make energy-saving strategies, etc., thus ensuring the QoS performance, QoE performance of the UE after handover, the performance after load migration, the performance after implementing the energy-saving strategy, avoiding ping-pong of energy-saving on/off, etc.

Embodiment 12 describes an aspect of supporting collection and processing of wireless communication network data according to the embodiment of the present disclosure.

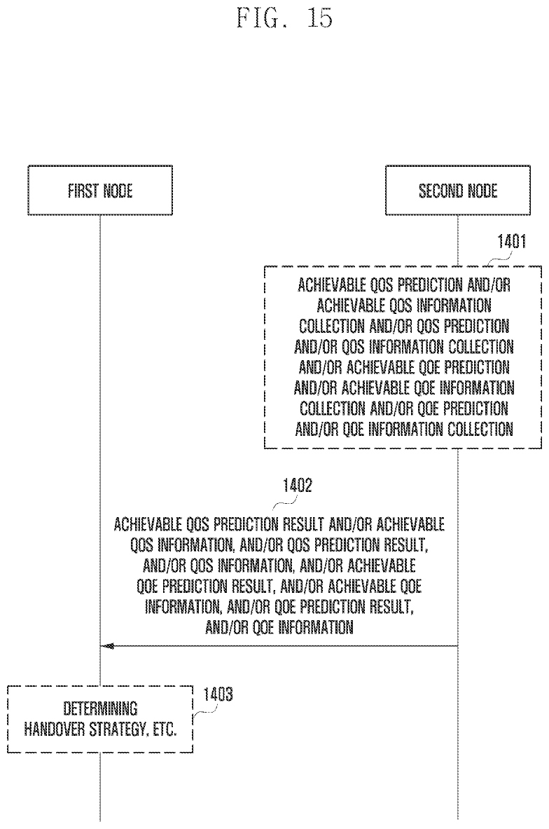

FIG. 15 illustrates another schematic diagram of a process of interaction of information associated with achievable QoS prediction, and/or achievable QoS, and/or QoS prediction, and/or QoS, and/or achievable QoE prediction, and/or achievable QoE, and/or QoE prediction, and/or QoE of a second node and/or a UE between a first node and the second node according to an embodiment of the present disclosure.

Step 1401, the second node performs the achievable QoS prediction and/or QoS prediction and/or achievable QoE prediction and/or QoE prediction based on the collected resource status and/or achievable QoS information and/or QoS information and/or achievable QoE information and/or QoE information; or the second node collects the information of achievable QoS and/or QoS and/or achievable QoE and/or QoE.

In an implementation, for example, the achievable QoS prediction and/or QoS prediction and/or achievable QoE prediction and/or QoE prediction can be implemented by a machine learning model.

Step 1402, the second node transmits the achievable QoS prediction result and/or achievable QoS information, and/or QoS prediction result, and/or QoS information, and/or achievable QoE prediction result, and/or achievable QoE information, and/or QoE prediction result, and/or QoE information of the second node and/or the UE to the first node according to its own situation, and informs the first node of the achievable QoS prediction result and/or achievable QoS information, and/or QoS prediction result, and/or QoS information, and/or achievable QoE prediction result, and/or achievable QoE information, and/or QoE prediction result, and/or QoE information of the second node and/or the UE.

In an implementation, for example, the achievable QoS prediction result and/or achievable QoS information, and/or QoS prediction result, and/or QoS information, and/or achievable QoE prediction result, and/or achievable QoE information, and/or QoE prediction result, and/or QoE information may be the aforementioned tenth message.

In an implementation, for example, the first node can be gNB or gNB CU-CP or en-gNB or eNB or ng-eNB, and the second node can be gNB or gNB CU-CP or en-gNB or eNB or ng-eNB.

In yet another implementation, for example, the first node may be gNB CU-CP and the second node may be gNB CU-UP.

In yet another implementation, for example, the first node may be gNB CU and the second node may be gNB DU.

Step 1403, the first node can determine a handover strategy for the UE according to the achievable QoS prediction result and/or achievable QoS information, and/or QoS prediction result, and/or QoS information, and/or achievable QoE prediction result, and/or achievable QoE information, and/or QoE prediction result, and/or QoE information of the second node and/or the UE, such as selecting the handover target node, deciding the load balancing decision, deciding the energy saving decision, etc.

In an implementation, for example, when determining the handover target node, the nodes of which the predicted achievable QoS prediction result cannot support the QoS requirement of the UE are excluded.

In another implementation, for example, when making load balancing decisions, the user loads with different QoS requirements are migrated to the neighbour nodes that can meet their QoS requirements.

In yet another implementation, for example, when the handover target node confirms, the nodes whose the predicted achievable QoE prediction result and/or the QoE prediction result cannot support the QoE requirement of the UE are excluded.

In yet another implementation, for example, when making load balancing decisions, user loads with different QoE requirements are migrated to corresponding neighboring nodes that can meet the respective QoE requirements.

In another implementation, for example, when making energy-saving decisions, if the self-load is small, but the achievable QoS and/or achievable QoE of neighbour nodes is reduced, energy-saving operation (such as station switch-off) will not be performed, so as to prevent the station start-up operation after a short time and the energy loss due to the on/off of the station.

In this way, according to its own situation, the second node provides the first node with the predicted and/or actual achievable QoS information and/or QoS information and/or achievable QoE information and/or QoE information of the second node and/or the UE within the requested time period, and provides reference information for the first node to select the handover target node, make load balance decisions, make energy-saving strategies, etc., thus ensuring the QoS performance, QoE performance of the UE after handover, the performance after load migration, the performance after implementing the energy-saving strategy, avoiding ping-pong of energy-saving on/off, etc.

Embodiment 13 describes an aspect of supporting collection and processing of wireless communication network data according to the embodiment of the present disclosure.

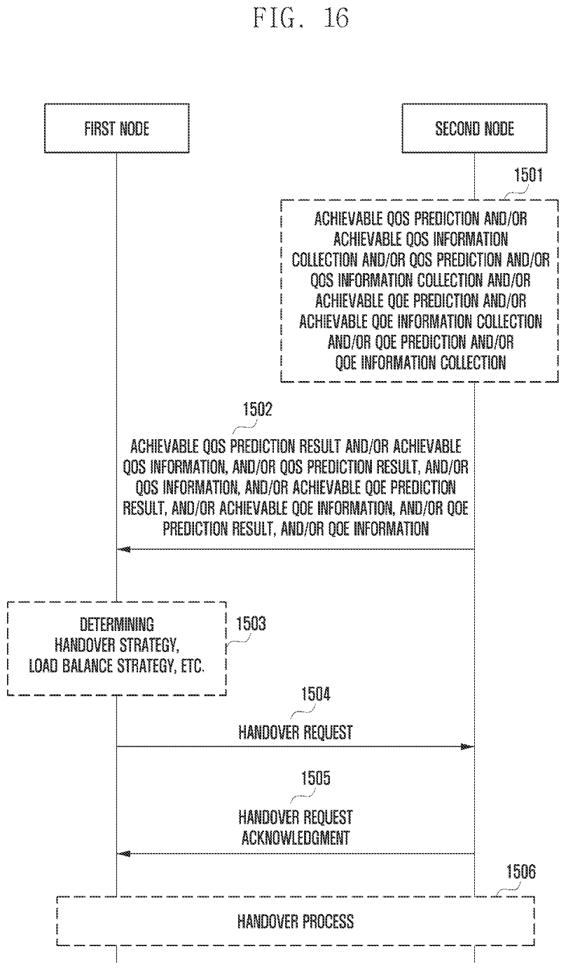

FIG. 16 illustrates yet another schematic diagram of a process of interaction of information associated with achievable QoS prediction, and/or achievable QoS, and/or QoS prediction, and/or QoS, and/or achievable QoE prediction, and/or achievable QoE, and/or QoE prediction, and/or QoE of a second node and/or UE between a first node and a second node according to an embodiment of the present disclosure.

Step 1501, the second node performs the achievable QoS prediction and/or QoS prediction and/or achievable QoE prediction and/or QoE prediction based on the collected resource status and/or achievable QoS information and/or QoS information and/or achievable QoE information and/or QoE information; or the second node collects the information of achievable QoS and/or QoS and/or achievable QoE and/or QoE.

In an implementation, for example, the achievable QoS prediction and/or QoS prediction and/or achievable QoE prediction and/or QoE prediction can be implemented by a machine learning model.

Step 1502, the second node transmits the achievable QoS prediction result and/or achievable QoS information, and/or QoS prediction result, and/or QoS information, and/or achievable QoE prediction result, and/or achievable QoE information, and/or QoE prediction result, and/or QoE information of the second node and/or the UE to the first node according to its own situation, and informs the first node of the achievable QoS prediction result and/or achievable QoS information, and/or QoS prediction result, and/or QoS information, and/or achievable QoE prediction result, and/or achievable QoE information, and/or QoE prediction result, and/or QoE information of the second node and/or the UE.

In an implementation, for example, the achievable QoS prediction result and/or achievable QoS information, and/or QoS prediction result, and/or QoS information, and/or achievable QoE prediction result, and/or achievable QoE information, and/or QoE prediction result, and/or QoE information may be the aforementioned tenth message.

In an implementation, for example, the first node can be gNB or gNB CU-CP or en-gNB or eNB or ng-eNB, and the second node can be gNB or gNB CU-CP or en-gNB or eNB or ng-eNB.

Step 1503, the first node can determine a handover strategy (such as selecting a handover target node) and decide a load balancing decision for the UE according to the achievable QoS prediction result and/or achievable QoS information, and/or QoS prediction result, and/or QoS information, and/or achievable QoE prediction result, and/or achievable QoE information, and/or QoE prediction result, and/or QoE information of the second node and/or the UE.

In an implementation, for example, when determining the handover target node, the nodes for which the predicted achievable QoS prediction result cannot support the QoS requirements of the UE are excluded.

In another implementation, for example, when making load balancing decisions, the user loads with different QoS requirements are migrated to the neighbor nodes that can meet their QoS requirements.

In yet another implementation, for example, when the handover target node confirms, the nodes whose the predicted achievable QoE prediction result and/or the QoE prediction result cannot support the QoE requirement of the UE are excluded.

In yet another implementation, for example, when making load balancing decisions, user loads with different QoE requirements are migrated to corresponding neighboring nodes that can meet the respective QoE requirements.

Step 1504, the first node transmits a handover request to the second node according to the selected target node or/and load balancing decision to hand over the UE or/and migrate the load.

Step 1505, the second node transmits a handover request acknowledgment to the first node to confirm the handover request.

Step 1506, the first node and the second node perform a handover process or a load migration process.

In this way, the second node provides the first node with the predicted and/or actual achievable QoS information and/or QoS information and/or achievable QoE information and/or QoE information of the second node and/or the UE in the requested time period according to its own situation, and provides reference information for the first node to select the handover target node, make the load balance decision, make the energy-saving strategy, etc., thus ensuring the QoS performance, QoE performance of the UE after the handover, the performance after the load migration and the performance after the implementation of the energy-saving strategy.

Embodiment 14 describes an aspect of supporting collection and processing of wireless communication network data according to the embodiment of the present disclosure.

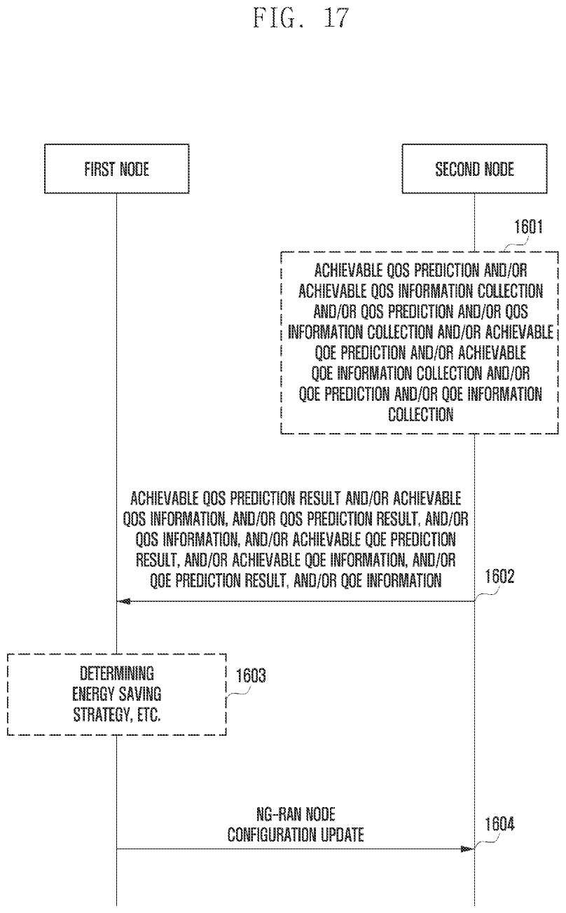

FIG. 17 illustrates further another schematic diagram of a process of interaction of information associated with achievable QoS prediction, and/or achievable QoS, and/or QoS prediction, and/or QoS, and/or achievable QoE prediction, and/or achievable QoE, and/or QoE prediction, and/or QoE of a second node and/or a UE between a first node and the second node according to an embodiment of the present disclosure.

Step 1601, the second node performs the achievable QoS prediction and/or QoS prediction and/or achievable QoE prediction and/or QoE prediction based on the collected resource status and/or achievable QoS information and/or QoS information and/or achievable QoE information and/or QoE information; or the second node collects the information of achievable QoS and/or QoS and/or achievable QoE and/or QoE.

In an implementation, for example, the achievable QoS prediction and/or QoS prediction and/or achievable QoE prediction and/or QoE prediction can be implemented by a machine learning model.

Step 1602, the second node transmits the achievable QoS prediction result and/or achievable QoS information, and/or QoS prediction result, and/or QoS information, and/or achievable QoE prediction result, and/or achievable QoE information, and/or QoE prediction result, and/or QoE information of the second node and/or the UE to the first node according to its own situation, and informs the first node of the achievable QoS prediction result and/or achievable QoS information, and/or QoS prediction result, and/or QoS information, and/or achievable QoE prediction result, and/or achievable QoE information, and/or QoE prediction result, and/or QoE information of the second node and/or the UE.

In an implementation, for example, the achievable QoS prediction result and/or achievable QoS information, and/or QoS prediction result, and/or QoS information, and/or achievable QoE prediction result, and/or achievable QoE information, and/or QoE prediction result, and/or QoE information may be the aforementioned tenth message.

In an implementation, for example, the first node can be gNB or gNB CU-CP or en-gNB or eNB or ng-eNB, and the second node can be gNB or gNB CU-CP or en-gNB or eNB or ng-eNB.

Step 1603, the first node can decide the node energy-saving decision according to the achievable QoS prediction result and/or achievable QoS information, and/or QoS prediction result, and/or QoS information, and/or achievable QoE prediction result, and/or achievable QoE information, and/or QoE prediction result, and/or QoE information of the second node and/or the UE.

In an implementation, when making energy-saving decisions, if the self-load is small, but the achievable QoS and/or achievable QoE of neighbour nodes is reduced, energy-saving operation (such as station switch-off) will not be performed, so as to prevent the station start-up operation after a short time and the energy loss due to the on/off of the station.

Step 1604, the first node informs the second node of the energy-saving decision through an NR-RAN node configuration update message.

Through the above method, the second node provides the first node with the predicted and/or actual achievable QoS information and/or QoS information and/or achievable QoE information and/or QoE information of the second node and/or the UE in the requested time period, and provides reference information for the first node to make the energy-saving decisions, etc., so as to ensure the performance of the first node after implementing the energy-saving decisions and avoid ping-pong of energy-saving on/off and the like.

The machine learning model for achievable QoS prediction and/or QoS prediction and/or achievable QoE prediction and/or QoE prediction in Embodiments 11, 12, 13 and 14 can be implemented in the following ways, for example.

The input of the models can include one or more of the following: the identity of the node, the time point, resource status, achievable QoS information, QoS information, achievable QoE information, QoE information, etc. The model can be trained by online learning, offline learning, supervised learning, unsupervised learning and reinforcement learning, etc. The models can include, but are not limited to, perceptron, feedforward neural network, radial basis network, deep feedforward network, recurrent neural network, long/short-term memory network, gated recurrent unit, auto encoder, and variational auto encoder, denoising auto encoder, sparse auto encoder, Markov chain, Hopfiled network, Boltzmann machine, restricted Boltzmann machine, deep belief network, deep convolutional network, deconvolutional network, deep convolutional inverse graphics network, generative adversarial network, liquid state machine, extrame learning machine, echo state network, deep residual network, Kohonen network, support vector machine, neural turing machine, convolutional neural network, artificial neural network, recurrent neural network, deep neural network, etc. The output of the models can include one or more of the following: the time point, the achievable highest packet loss rate, the achievable lowest packet loss rate, the achievable maximum delay, the achievable lowest delay, the achievable highest throughput, the achievable lowest throughput, the achievable highest data rate, the achievable lowest data rate, the achievable 5QI type, a predicted value of the achievable QoS evaluation value, a predicted value of the QoS parameter, a predicted value of the QoS evaluation value, a predicted value of the QoE parameter, a predicted value of the achievable QoE parameter, a predicted value of a RAN visible QoE parameter, a predicted value of the achievable RAN visible QoE parameter, a predicted value of the QoE evaluation value, a predicted value of the achievable QoE evaluation value, a predicted value of the RAN visible QoE evaluation value, a predicted value of the achievable RAN visible QoE evaluation value and so on.

Embodiment 15 describes an aspect of supporting collection and processing of wireless communication network data according to the embodiment of the present disclosure.

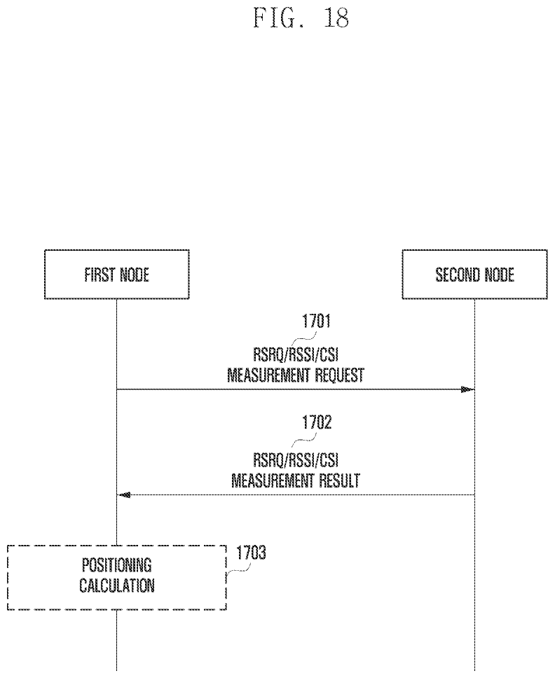

FIG. 18 illustrates another schematic diagram of a process of interaction of information related to positioning of user equipment between a first node and a second node according to an embodiment of the present disclosure.

Step 1701, the first node transmits an RSRQ and/or RSSI and/or CSI measurement request to the second node to inform the second node to feedback the corresponding measurement result.

In an implementation, for example, the RSRQ and/or RSSI and/or CSI measurement request may be the aforementioned eleventh message.

In an implementation, for example, the first node can be gNB or gNB CU-CP or en-gNB or eNB or ng-eNB, and the second node can be gNB or gNB CU-CP or en-gNB or eNB or ng-eNB.

In yet another implementation, for example, the first node may be gNB CU-CP and the second node may be gNB CU-UP.

In yet another implementation, for example, the first node may be gNB CU and the second node may be gNB DU.

In yet another implementation, for example, the first node can be LMF or AMF, and the second node can be gNB or gNB CU-CP or en-gNB or eNB or ng-eNB.

Step 1702, the second node feeds back the RSRQ and/or RSSI and/or CSI measurement result to the first node according to the measurement request of step 1701.

In an implementation, for example, the RSRQ and/or RSSI and/or CSI measurement result may be the aforementioned twelfth message.

Step 1703, the first node can perform positioning calculation according to the measurement result received in step 1702. In an implementation, for example, the positioning calculation can be implemented by a machine learning model.

Through the above method, the second node provides the measurement result of RSRQ and/or RSSI and/or CSI parameters to the first node, and provides reference information for the first node to perform positioning calculation on a UE, etc., so as to improve positioning accuracy, reduce positioning delay, reduce signalling overhead required for positioning, and reduce positioning errors caused by the node synchronization.

Embodiment 16 describes a schematic diagram of an aspect of supporting collection and processing of wireless communication network data according to an embodiment of the present disclosure.

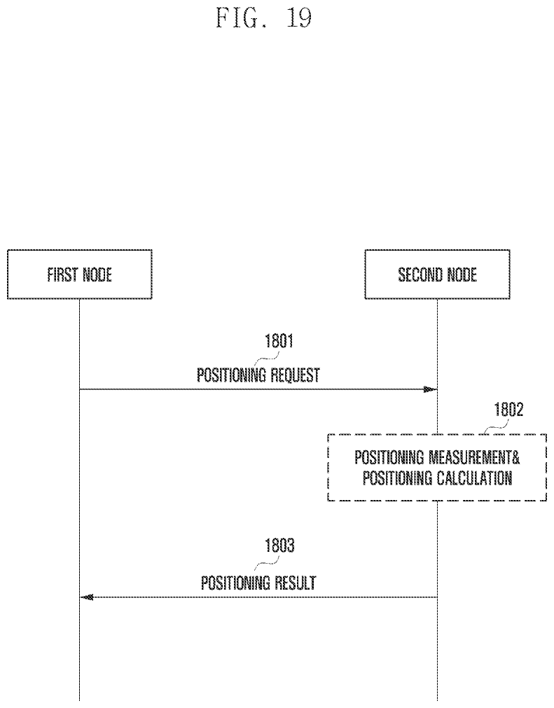

FIG. 19 illustrates another schematic diagram of a process of interaction of information related to positioning of user equipment between a first node and a second node according to an embodiment of the present disclosure.

Step 1801, the first node transmits a positioning request to the second node to inform the second node to feedback the corresponding positioning result.

In an implementation, for example, the positioning request may be the aforementioned thirteenth message.

In an implementation, for example, the first node can be gNB or gNB CU-CP or en-gNB or eNB or ng-eNB, and the second node can be gNB or gNB CU-CP or en-gNB or eNB or ng-eNB.

In yet another implementation, for example, the first node may be gNB CU-CP and the second node may be gNB CU-UP.

In yet another implementation, for example, the first node may be gNB CU and the second node may be gNB DU.

In yet another implementation, for example, the first node can be LMF or AMF, and the second node can be gNB or gNB CU-CP or en-gNB or eNB or ng-eNB.

Step 1802, the second node can collect corresponding measurement result and perform positioning calculation according to the positioning request received in step 1801.

In an implementation, for example, the positioning calculation can be implemented by a machine learning model.

Step 1803, the second node transmits the positioning result to the first node.

In an implementation, for example, the positioning result may be the fourteenth message mentioned above.

Through the above method, the second node provides the first node with the positioning result calculated by the second node, so as to improve the positioning accuracy, reduce the positioning time delay, reduce the signalling overhead required for positioning and reduce the positioning error caused by the node synchronization.

The machine learning model for positioning in Embodiments 15 and 16 can be implemented as follows, for example.

The input of the models can include one or more of the following: the identity of the UE, the time point, positioning parameter measurement information, positioning parameter measurement result, etc. The models can be trained by online learning, offline learning, supervised learning, unsupervised learning and reinforcement learning, etc. The models can include, but are not limited to, perceptron, feedforward neural network, radial basis network, deep feedforward network, recurrent neural network, long/short-term memory network, gated recurrent unit, auto encoder, and variational auto encoder, denoising auto encoder, sparse auto encoder, Markov chain, Hopfiled network, Boltzmann machine, restricted Boltzmann machine, deep belief network, deep convolutional network, deconvolutional network, deep convolutional inverse graphics network, generative adversarial network, liquid state machine, extrame learning machine, echo state network, deep residual network, Kohonen network, support vector machine, neural turing machine, convolutional neural network, artificial neural network, recurrent neural network, deep neural network, etc. The output of the models can include one or more of the following: positioning coordinates, etc.

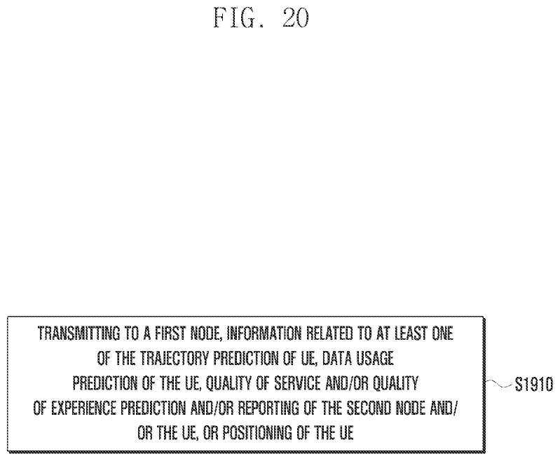

Please refer to FIG. 20, which illustrates a flow chart of a method performed by a second node provided by an embodiment of the present disclosure, which includes step S1910 and step S1920.

Step S1910, transmitting to a first node, information related to at least one of the trajectory prediction of user equipment, data usage prediction of the user equipment, quality of service and/or quality of experience prediction and/or reporting of the second node and/or the UE, or positioning of the user equipment.

As an implementation, at least one of the trajectory prediction, the data usage prediction, the achievable quality of service prediction, or the positioning related operation is performed based on a machine learning model.

Through the above method, the second node can perform the trajectory prediction of user equipment, the data usage prediction of the user equipment, the positioning related operation of the user equipment, or quality of service and/or quality of experience prediction and/or reporting of the second node and/or the UE, and feedback information related to at least one of the trajectory prediction of user equipment, the data usage prediction of the user equipment, quality of service and/or quality of experience prediction and/or reporting of the second node and/or the UE, or the positioning of the user equipment to the first node, and based on the above information, perform the corresponding operation, so as to provide reference information for the first node to make a decision on whether to hand over the UE, the decision on the handover time, the selection of the target node, etc., so as to reduce the cases of handover failures, handover ping-pong, too many candidate target nodes, etc., thereby improving the success rate of handover; and the first node makes the decision of resource allocation to UE, thus improving the effectiveness of resource allocation; in addition, it also provides reference information for the first node to make energy saving, load balancing, etc., so as to ensure the QoS performance after UE handover, the performance after load migration, the performance after the implementation of energy-saving strategy and avoid ping-pong of energy-saving on/off; furthermore, it also provides reference information for the first node or other nodes to make positioning results, etc., so as to improve positioning accuracy, reduce positioning delay, reduce signalling overhead required for positioning, and reduce positioning errors caused by the node synchronization.

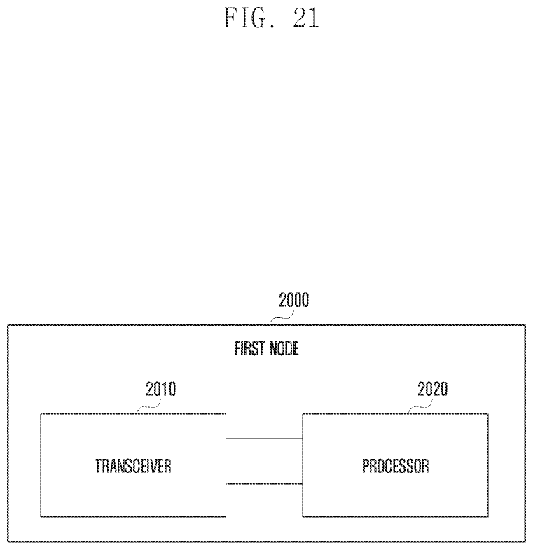

FIG. 21 is a block diagram illustrating the structure of a first node 2000 according to an embodiment of the present disclosure.

Referring to FIG. 21, a first node 2000 includes a transceiver 2010 and a processor 2020. The transceiver 2010 is configured to transmit and receive signals to and from the outside. The processor 2020 is configured to perform any of the above method performed by the first node. The first node 2000 can be implemented in the form of hardware, software or a combination of hardware and software, so that it can perform the method performed by the first node described in the present disclosure.

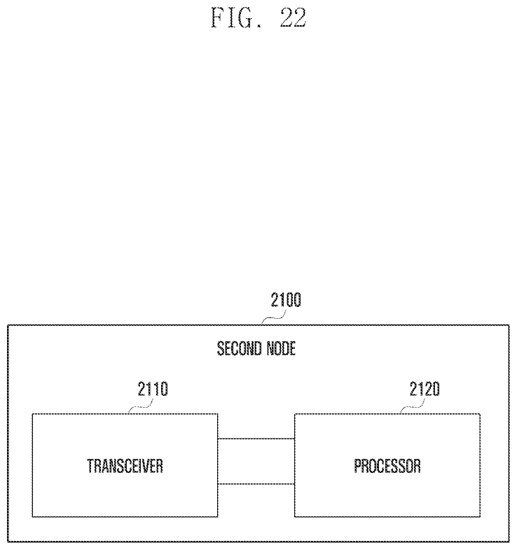

FIG. 22 is a block diagram illustrating the structure of a second node 2100 according to an embodiment of the present disclosure.

Referring to FIG. 22, a second node 2100 includes a transceiver 2110 and a processor 2120. The transceiver 2110 is configured to transmit and receive signals to and from the outside. The processor 2120 is configured to perform any of the above method performed by the second node. The second node 2100 can be implemented in the form of hardware, software or a combination of hardware and software, so that it can perform the method performed by the second node described in the present disclosure.

At least one embodiment of the present disclosure also provides a non-transitory computer-readable recording medium having stored thereon a program, which when performed by a computer, performs the methods described above.

According to an aspect of the present disclosure, there is provided a method performed by a first node, comprising: acquiring information related to at least one of trajectory prediction of user equipment, data usage prediction of the user equipment, quality of service and/or quality of experience prediction and/or reporting of a second node and/or a UE, or positioning of the user equipment; performing a corresponding operation based on the information.

According to the method performed by the first node provided by the present disclosure, wherein acquiring information related to the trajectory prediction of the user equipment, comprises: receiving a second message transmitted by the second node, wherein the second message includes information related to trajectory prediction of the user equipment; wherein the information related to the trajectory prediction of the user equipment includes at least one of the following: a prediction identity of prediction content, which is related information used to indicate whether trajectory information is the prediction content; user equipment handover time, which is related information used to identify handover time of the user equipment; requested content confirmation, which is related information used to confirm whether the requested trajectory prediction content is predicted or not; a time interval for prediction result, which is related information used to indicate a time interval for trajectory prediction result; a type of prediction, which is related information used to indicate a type of the performed trajectory prediction; content of prediction, which is related information used to indicate parameters of the performed trajectory prediction; related information used to indicate reasons for a trajectory prediction request failure.

The method performed by the first node provided by the present disclosure further comprises: transmitting a first message to the second node, the first message includes related information for requesting trajectory prediction of the user equipment; wherein the related information for requesting trajectory prediction of the user equipment includes at least one of the following: handover time of requested user equipment, which is related information used to identify handover time of the requested user equipment; a prediction identity, which is used to identify whether the first message includes related information for requesting trajectory prediction of the user equipment; a prediction registration request, which is related information used to indicate at least one of the start, end or add of the trajectory prediction request; a time interval for the requested prediction result, which is related information used to indicate the requested time interval for trajectory prediction result; a reporting type of the requested prediction result, which is related information used to indicate whether the reporting of the requested trajectory prediction result is one-time reporting or periodic reporting; a reporting period of the requested prediction result, which is related information used to indicate a corresponding interval time when the reporting of the requested trajectory prediction result is periodic reporting; a reporting triggering condition, which is related information used to indicate triggering conditions under which the reporting is needed; a type of the requested prediction, which is related information used to indicate a type of the requested trajectory prediction; content of the requested prediction, which is related information used to indicate parameters of the requested trajectory prediction.

According to the method performed by the first node provided by the present disclosure, herein acquiring information related to the positioning of the user equipment, comprises: receiving a fourteenth message transmitted by the second node, wherein the fourteenth message includes the information related to the positioning of the user equipment; wherein the fourteenth message includes at least one of the following: a node identity, which is related information used to identify nodes participating in the positioning; location information related information; an acquisition mode, which is related information used to indicate a method used in the performed positioning; a calculation method, which is related information used to indicate a calculation method used in the performed positioning; related information of prediction accuracy, related information used to indicate reasons for a positioning failure; related information of measured positioning parameters.

The method performed by the first node according to the present disclosure further comprises: transmitting a thirteenth message to the second node, the thirteenth message includes information for requesting positioning of the user equipment; wherein the thirteenth message includes at least one of the following: a requested positioning node identity, which is related information used to identify requested nodes for participating in the positioning; a requested positioning acquisition mode, which is related information used to indicate requested method used in the positioning; related information of positioning parameter requested to measure.

According to the method performed by the first node provided by the present disclosure, wherein acquiring information related to data usage prediction of the user equipment, comprises: receiving a sixth message transmitted by the second node, wherein the sixth message includes information related to data usage prediction of the user equipment; wherein the sixth message includes at least one of the following: user equipment handover time, which is related information used to identify handover time of the user equipment; requested content confirmation, which is related information used to confirm whether the content of the requested data usage prediction is predicted or not; a prediction identity of prediction content, which is related information used to indicate whether the data usage information is the prediction content; a time interval for prediction result, which is related information used to indicate a time interval for data usage prediction result; a type of prediction, which is related information used to indicate a type of the performed data usage prediction; content of prediction, which is related information used to indicate parameters of the performed data usage prediction; related information used to indicate reasons for a data usage request failure.

According to the method performed by the first node provided by the present disclosure, the method further comprises: transmitting a fifth message to the second node, the fifth message includes related information for requesting data usage prediction of the user equipment; wherein the related information for requesting data usage prediction of the user equipment includes at least one of the following: handover time of the requested user equipment, which is related information used to identify handover time of the requested user equipment; a prediction identity, which is used to identify whether the fifth message includes related information for requesting data usage prediction of the user equipment; a prediction registration request, which is related information used to indicate at least one of the start, end or add of a data usage prediction request; a time interval for the requested prediction result, which is related information used to indicate the requested time interval for the data usage prediction result; a reporting type of the requested prediction result, which is related information used to indicate whether the reporting of the requested data usage prediction result is one-time reporting or periodic reporting; a reporting period of the requested prediction result, which is related information used to indicate a corresponding interval time when the reporting of the requested data usage prediction result is periodic reporting; reporting triggering conditions, which is related information used to indicate triggering conditions under which the reporting is needed; a type of the requested prediction, which is related information used to indicate a type of the requested data usage prediction; and the requested content of prediction, which is related information used to indicate parameters of the requested data usage prediction.

According to the method performed by the first node provided by the present disclosure, the method further comprises: transmitting a fourth message to the second node, wherein the fourth message includes information about the requested reporting requirement of the data usage; receiving data usage information of the user equipment in the second node transmitted by the second node according to the reporting requirement; wherein the fourth message includes at least one of the following: requested reporting scope, which is related information used to indicate whether the requested reporting scope includes multi radio dual connectivity; a requested type of data usage reporting, which is related information used to indicate the data usage information type requested to report; a requested reporting type, which is related information used to indicate a type requested to report; reporting registration request, which is related information used to indicate the start and/or end and/or add of reporting; a reporting interval, which is related information used to indicate the corresponding interval time when the reporting type is periodic reporting; a measurement interval, which is related information used to indicate a counting interval of the data usage type requested to report.

The method performed by the first node provided by the present disclosure, wherein acquiring information related to achievable quality of service prediction of the user equipment, comprises: receiving a tenth message transmitted by the second node, wherein the tenth message includes information related to the quality of service and/or quality of experience prediction and/or reporting of the second node and/or the UE; wherein the tenth message includes at least one of the following: requested content confirmation, which is related information used to confirm at least one of whether the content of the requested achievable quality of service prediction is predicted or not, whether the achievable quality of service can be reported, whether the content of quality of service prediction is predicted, whether the quality of service can be reported, whether the content of achievable quality of experience prediction is predicted, whether the achievable quality of experience can be reported, whether the content of quality of experience prediction is predicted and whether the quality of experience can be reported; a prediction identity of prediction content, which is related information used to indicate whether achievable quality of service information, quality of service information, achievable quality of experience information, quality of experience information is the prediction content; a prediction interval of prediction content, which is used to indicate related information of the time interval for the achievable quality of service prediction, related information of the time interval for quality of service prediction, related information of the time interval for achievable quality of experience information prediction, related information of the time interval for quality of experience information prediction; achievable quality of service parameters, which are related information used to indicate parameters of achievable quality of service prediction; related information used to indicate reasons for request failure of an achievable quality of service prediction and/or achievable quality of service reporting and/or quality of service prediction and/or quality of service reporting and/or achievable quality of experience prediction and/or achievable quality of experience reporting and/or quality of experience prediction and/or quality of experience reporting; a UE identity, used to identify the object UE to which the information belongs; reporting content, used to indicate the reported parameter information; triggering event of reporting, used to indicate the triggering event of the reporting at this time; counting and/or prediction granularity for the reported parameters, used to indicate the granularity of the counting and/or prediction for the reported parameters; and identity and/or identity list of the range for the reported counting and/or prediction, used to indicate the identity and/or identity list of the range for the reported counting and/or prediction.

According to the method performed by the first node provided by the present disclosure, the method further comprises: transmitting an eighth message to the second node, wherein the eighth message includes related information for requesting quality of service and/or quality of experience prediction and/or reporting of the second node and/or the UE; wherein the related information for requesting quality of service and/or quality of experience prediction and/or reporting of the second node and/or the UE includes at least one of the followings: a prediction identity, which is used to identify whether the eighth message includes related information for requesting at least one of achievable quality of service prediction, quality of service prediction, achievable quality of experience prediction, quality of experience prediction of the second node and/or the user equipment; a prediction registration request, which is related information used to indicate at least one of the start, end or add of an achievable quality of service prediction request, quality of service prediction request, achievable quality of experience prediction request, quality of experience prediction request; a prediction type, which is related information used to indicate a type of the requested achievable quality of service prediction, the requested achievable quality of experience prediction, the requested prediction; a prediction time interval, which is related information used to indicate a time interval for the prediction of at least one of the requested achievable quality of service, quality of service, achievable quality of experience, quality of experience; a prediction result reporting type, which is related information used to indicate whether at least one of the requested achievable quality of service prediction result, quality of service prediction result, achievable quality of experience prediction result, quality of experience prediction result is one-time reporting or periodic reporting; a reporting period of prediction result, which is related information used to indicate a corresponding interval time when the reporting of at least one of the requested achievable quality of service prediction result, quality of service prediction result, achievable quality of experience prediction result, quality of experience prediction result is periodic reporting; reporting triggering conditions, which is related information used to indicate triggering conditions under which the reporting is needed; a prediction type, which is related information used to indicate a type of the requested achievable quality of service prediction and/or achievable quality of experience prediction; prediction content, which is related information used to indicate at least one of parameters of the requested achievable quality of service prediction, quality of service prediction, achievable quality of experience prediction, quality of experience prediction; an identity of the object to which the requested information belongs, which is used to indicate the entity to which the requested information that needs to be fed-back belongs; a UE identity, which is used to identify the identity of the belonged object UE when the object of the requested information is UE; requested counting and/or prediction granularity, which is used to indicate the granularity of requested counting and/or prediction; a identity and/or identity list of the range for requested counting and/or prediction, which is used to indicate the identity and/or identity list of the range for the requested counting and/or prediction; a registration request, which is used to indicate the related information of at least one of the start, end or addition of the request; a requested type, which is used to indicate the type of the requested reporting and/or prediction; a reporting time interval, which is used to indicate the time interval in which the requested reporting content and/or prediction content need to be fed-back; a reporting type, which is related information used to indicate whether the reporting type of the requested reporting content and/or prediction content is one-time reporting or periodic reporting or event-triggered reporting; a result reporting period, which is used to indicate that related information of corresponding interval time when the requested reporting content and/or prediction content is periodic reporting; and requested reporting content, which is used to indicate the requested parameter information to be reported.

According to an aspect of the present disclosure, there is provided a method performed by a second node, comprising: transmitting, to a first node, information related to at least one of the trajectory prediction of the UE, the data usage prediction of the UE, the quality of service and/or quality of experience prediction and/or reporting of the second node and/or the UE, or the positioning of the user equipment.

Alternatively, the second node may also perform at least one of the following operations: performing trajectory prediction of the UE, data usage prediction of the UE, positioning related operations of the user equipment, or performing quality of service and/or quality of experience prediction and/or reporting of the second node and/or the user equipment.

According to the method performed by the second node provided by the present disclosure, wherein at least one of the trajectory prediction, the data usage prediction, the quality of service and/or quality of experience prediction, or the positioning related operation is performed based on a machine learning model.

According to an aspect of the present disclosure, there is provided a first node, comprising: a transceiver configured to transmit and receive signals with the outside; and a processor configured to control the transceiver to perform any of the above methods performed by the first node.

According to an aspect of the present disclosure, there is provided a second node, comprising: a transceiver configured to transmit and receive signals with the outside; and a processor configured to control the transceiver to perform any of the above methods performed by the second node.

1. A method performed by a first node, the method comprising:
acquiring information related to at least one of trajectory prediction of user equipment, data usage prediction of the user equipment, quality of service and/or quality of experience prediction and/or reporting of a second node and/or a user equipment, or positioning of the user equipment;
performing a corresponding operation based on the information.

2. The method of claim 1, wherein the quality of service and/or quality of experience prediction and/or reporting of the second node and/or the user equipment comprises at least one of the followings:
achievable quality of service prediction;
achievable quality of service reporting;
quality of service prediction;
quality of service reporting;
achievable quality of experience prediction;
achievable quality of experience reporting;
quality of experience prediction; and
quality of experience reporting.

3. The method of claim 1, wherein acquiring information related to the trajectory prediction of the user equipment, comprises:
receiving a second message transmitted by the second node, wherein the second message includes information related to trajectory prediction of the user equipment;
wherein the information related to the trajectory prediction of the user equipment includes at least one of the following;
a prediction identity of prediction content, which is related information used to indicate whether trajectory information is the prediction content;
user equipment handover time, which is related information used to identify handover time of the user equipment;
requested content confirmation, which is related information used to confirm whether the requested trajectory prediction content is predicted or not;
a time interval for prediction result, which is related information used to indicate a time interval for trajectory prediction result;
a type of prediction, which is related information used to indicate a type of the performed trajectory prediction;
content of prediction, which is related information used to indicate parameters of the performed trajectory prediction;
related information used to indicate reasons for a trajectory prediction request failure.

4. The method of claim 1, further comprises:
transmitting a first message to the second node, the first message includes related information for requesting trajectory prediction of the user equipment;
wherein the related information for requesting trajectory prediction of the user equipment includes at least one of the following:
handover time of requested user equipment, which is related information used to identify handover time of the requested user equipment;
a prediction identity, which is used to identify whether the first message includes related information for requesting trajectory prediction of the user equipment;
a prediction registration request, which is related information used to indicate at least one of the start, end or add of the trajectory prediction request;
a time interval for the requested prediction result, which is related information used to indicate the requested time interval for trajectory prediction result;
a reporting type of the requested prediction result, which is related information used to indicate whether the reporting of the requested trajectory prediction result is one-time reporting or periodic reporting;
a reporting period of the requested prediction result, which is related information used to indicate a corresponding interval time when the reporting of the requested trajectory prediction result is periodic reporting;
reporting triggering conditions, which is related information used to indicate triggering conditions under which the reporting is needed;
a type of the requested prediction, which is related information used to indicate a type of the requested trajectory prediction;
content of the requested prediction, which is related information used to indicate parameters of the requested trajectory prediction.

5. The method of claim 1, wherein acquiring information related to the positioning of the user equipment, comprises:
receiving a fourteenth message transmitted by the second node, wherein the fourteenth message includes the information related to the positioning of the user equipment;
wherein the fourteenth message includes at least one of the following:
a node identity, which is related information used to identify nodes participating in the positioning;
location information related information;
an acquisition mode, which is related information used to indicate a method used in the performed positioning;
a calculation method, which is related information used to indicate a calculation method used in the performed positioning;
related information of prediction accuracy,
related information used to indicate reasons for a positioning failure;
related information of measured positioning parameters.

6. The method of claim 1, further comprises:
transmitting a thirteenth message to the second node, the thirteenth message includes information for requesting positioning of the user equipment;
wherein the thirteenth message includes at least one of the following:
a requested positioning node identity, which is related information used to identify requested nodes for participating in the positioning;
a requested positioning acquisition mode, which is related information used to indicate requested method used in the positioning;
related information of positioning parameter requested to measure.

7. The method of claim 1, wherein acquiring information related to data usage prediction of the user equipment, comprises:
receiving a sixth message transmitted by the second node, wherein the sixth message includes information related to data usage prediction of the user equipment;
wherein the sixth message includes at least one of the following:
user equipment handover time, which is related information used to identify handover time of the user equipment;
requested content confirmation, which is related information used to confirm whether the content of the requested data usage prediction is predicted or not;
a prediction identity of prediction content, which is related information used to indicate whether the data usage information is the prediction content;
a time interval for prediction result, which is related information used to indicate a time interval for data usage prediction result;
a type of prediction, which is related information used to indicate a type of the performed data usage prediction;
content of prediction, which is related information used to indicate parameters of the performed data usage prediction;
related information used to indicate reasons for a data usage request failure.

8. The method of claim 1, further comprises:
transmitting a fifth message to the second node, the fifth message includes related information for requesting data usage prediction of the user equipment;
wherein the related information for requesting data usage prediction of the user equipment includes at least one of the following:
handover time of the requested user equipment, which is related information used to identify handover time of the requested user equipment;
a prediction identity, which is used to identify whether the fifth message includes related information for requesting data usage prediction of the user equipment;
a prediction registration request, which is related information used to indicate at least one of the start, end or add of a data usage prediction request;
a time interval for the requested prediction result, which is related information used to indicate the requested time interval for the data usage prediction result;
a reporting type of the requested prediction result, which is related information used to indicate whether the reporting of the requested data usage prediction result is one-time reporting or periodic reporting;
a reporting period of the requested prediction result, which is related information used to indicate a corresponding interval time when the reporting of the requested data usage prediction result is periodic reporting;
reporting triggering conditions, which is related information used to indicate triggering conditions under which the reporting is needed:
a type of the requested prediction, which is related information used to indicate a type of the requested data usage prediction; and
the requested content of prediction, which is related information used to indicate parameters of the requested data usage prediction.

9. The method of claim 1, further comprises:
transmitting a fourth message to the second node, wherein the fourth message includes information about the requested reporting requirement of the data usage;
receiving data usage information of the user equipment in the second node transmitted by the second node according to the reporting requirement;
wherein the fourth message includes at least one of the following:
requested reporting scope, which is related information used to indicate whether the requested reporting scope includes multi radio dual connectivity;
a requested type of data usage reporting, which is related information used to indicate the data usage information type requested to report;
a requested reporting type, which is related information used to indicate a type requested to report;
reporting registration request, which is related information used to indicate the start and/or end and/or add of reporting;
a reporting interval, which is related information used to indicate the corresponding interval time when the reporting type is periodic reporting;
a measurement interval, which is related information used to indicate a counting interval of the data usage type requested to report.

10. The method of claim 2, wherein acquiring information related to quality of service and/or quality of experience prediction and/or reporting, comprises:
receiving a tenth message transmitted by the second node, wherein the tenth message includes information related to the quality of service and/or quality of experience prediction and/or reporting of the second node and/or the user equipment;
wherein the tenth message includes at least one of the following:
requested content confirmation, which is related information used to confirm at least one of whether the content of the requested achievable quality of service prediction is predicted or not, whether the achievable quality of service can be reported, whether the content of quality of service prediction is predicted, whether the quality of service can be reported, whether the content of achievable quality of experience prediction is predicted, whether the achievable quality of experience can be reported, whether the content of quality of experience prediction is predicted and whether the quality of experience can be reported;
a prediction identity of prediction content, which is related information used to indicate whether achievable quality of service information, quality of service information, achievable quality of experience information, quality of experience information is the prediction content;
a prediction interval of prediction content, which is used to indicate related information of the time interval for the achievable quality of service prediction result, related information of the time interval of quality of service prediction, related information of the time interval of achievable quality of experience information prediction, related information of the time interval of quality of experience information prediction;
achievable quality of service parameters, which are related information used to indicate parameters of achievable quality of service prediction;
related information used to indicate reasons for a request failure of the quality of service and/or quality of experience prediction and/or reporting;
a UE identity, which is used to identify the object UE to which the information belongs;
reporting content, which is used to indicate the reported parameter information;
triggering event of reporting, which is used to indicate the triggering event of the reporting;
counting and/or prediction granularity for the reported parameters, which is used to indicate the granularity of counting and/or prediction for the reported parameters; and
a identity and/or identity list of the range for reported counting and/or prediction, which is used to indicate the identity and/or identity list of the range for the reported counting and/or prediction.

11. The method of claim 2, further comprises:
transmitting an eighth message to the second node, wherein the eighth message includes related information for requesting quality of service and/or quality of experience prediction and/or reporting of the second node and/or the user equipment;
wherein the related information for requesting quality of service and/or quality of experience prediction and/or reporting of the second node and/or the user equipment includes at least one of the followings:
a prediction identity, which is used to identify whether the eighth message includes related information for requesting at least one of achievable quality of service prediction, quality of service prediction, achievable quality of experience prediction, quality of experience prediction of the second node and/or the user equipment;
a prediction registration request, which is related information used to indicate at least one of the start, end or add of an achievable quality of service prediction request, quality of service prediction request, achievable quality of experience prediction request, quality of experience prediction request;
a prediction type, which is related information used to indicate a type of the requested achievable quality of service prediction, the requested achievable quality of experience prediction, the requested prediction;
a prediction time interval, which is related information used to indicate a time interval for the prediction of at least one of the requested achievable quality of service, quality of service, achievable quality of experience, quality of experience;
a prediction result reporting type, which is related information used to indicate whether at least one of the requested achievable quality of service prediction result, quality of service prediction result, achievable quality of experience prediction result, quality of experience prediction result is one-time reporting or periodic reporting;
a reporting period of prediction result, which is related information used to indicate a corresponding interval time when the reporting of at least one of the requested achievable quality of service prediction result, quality of service prediction result, achievable quality of experience prediction result, quality of experience prediction result is periodic reporting;
reporting triggering conditions, which is related information used to indicate triggering conditions under which the reporting is needed;
a prediction type, which is related information used to indicate a type of the requested achievable quality of service prediction and/or achievable quality of experience prediction;
prediction content, which is related information used to indicate at least one of parameters of the requested achievable quality of service prediction, quality of service prediction, achievable quality of experience prediction, quality of experience prediction;
an identity of the object to which the requested information belongs, which is used to indicate the entity to which the requested information that needs to be fed-back belongs;
a UE identity, which is used to identify the identity of the belonged object UE when the object of the requested information is UE;
requested counting and/or prediction granularity, which is used to indicate the granularity of requested counting and/or prediction;
a identity and/or identity list of the range for the requested counting and/or prediction, which is used to indicate the identity and/or identity list of the range for the requested counting and/or prediction;
a registration request, which is used to indicate the related information of at least one of the start, end or addition of the request;
a requested type, which is used to indicate the type of the requested reporting and/or prediction;
a reporting time interval, which is used to indicate the time interval in which the requested reporting content and/or prediction content need to be fedback;
a reporting type, which is related information used to indicate whether the reporting type of the requested reporting content and/or prediction content is one-time reporting or periodic reporting or event-triggered reporting;
a result reporting period, which is used to indicate that related information of corresponding interval time when the requested reporting content and/or prediction content is periodic reporting; and
requested reporting content, which is used to indicate the requested parameter information to be reported.

12. A method performed by a second node, the method comprising:
transmitting, to a first node, information related to at least one of trajectory prediction of a user equipment, data usage prediction of the user equipment, quality of service and/or quality of experience prediction and/or reporting of the second node and/or the user equipment, positioning the user equipment.

13. The method of claim 12, wherein the quality of service and/or quality of experience prediction and/or reporting of the second node and/or the user equipment comprises at least one of the followings:
achievable quality of service prediction;
achievable quality of service reporting;
quality of service prediction;
quality of service reporting;
achievable quality of experience prediction;
achievable quality of experience reporting;
quality of experience prediction; and
quality of experience reporting.

14. A first node, comprising:
a transceiver configured to transmit and receive signals with the outside; and
a processor configured to control the transceiver,
wherein the processor further configured to acquire information related to at least one of trajectory prediction of user equipment, data usage prediction of the user equipment, quality of service and/or quality of experience prediction and/or reporting of a second node and/or a user equipment, or positioning of the user equipment, and perform a corresponding operation based on the information.

15. A second node, comprising:
a transceiver configured to transmit and receive signals with the outside; and
a processor configured to control the transceiver,
wherein the processor further configured to transmit, to a first node, information related to at least one of trajectory prediction of a user equipment, data usage prediction of the user equipment, quality of service and/or quality of experience prediction and/or reporting of the second node and/or the user equipment, positioning the user equipment.
